(19) United States
(12) Patent Application Publication
(10) Pub. No.: US 2017/0288272 A1
(43) Pub. Date: Oct. 5, 2017

(54) LASER PATTERNED THIN FILM BATTERY

(71) Applicant: APPLIED MATERIALS, INC., Santa Clara, CA (US)

(72) Inventors: Byung Sung Leo KWAK, Portland, OR (US); Daoying SONG, San Jose, CA (US)

(21) Appl. No.: 15/508,374

(22) PCT Filed: Sep. 4, 2015
(86) PCT No.: PCT/US2015/048643

§ 371 Date: Mar. 2, 2017

Related U.S. Application Data
(60) Provisional application No. 62/046,051, filed on Sep. 4, 2014.

(51) Int. Cl. H01M 10/0585; H01M 10/0562; H01M 10/42; H01M 10/04

(52) U.S. Cl. CPC H01M 10/0585; H01M 10/0436; H01M 10/0562; H01M 10/4235

(57) ABSTRACT

A thin film battery may include a substrate; with a cathode current collector layer an anode current collector layer, a cathode layer, an electrolyte layer, and an anode layer, wherein a portion of an anode contact area of the anode current collector is not covered by the anode layer, and wherein an electrically insulating buffer area in the electrolyte layer, for electrically isolating the laser cut edge of the cathode layer adjacent to the contact area of the cathode current collector from the laser cut edge of the anode layer, is not covered by the anode layer, the electrically insulating buffer area being between the contact area of the cathode current collector layer and the anode layer, Methods and apparatus for forming thin film batteries are also described herein.

### CROSS-REFERENCE TO RELATED APPLICATIONS

This application claims the benefit of U.S. Provisional Application No. 62/046,051 filed Sep. 4, 2014.

### FIELD

Embodiments of the present disclosure relate generally to electrochemical devices and methods of making the same, and more specifically, although not exclusively, to laser patterned thin film batteries.

### BACKGROUND

Thin film batteries (TFBs) may comprise a thin film stack of layers including current collectors, a cathode (positive electrode), a solid state electrolyte and an anode (negative electrode). TFBs, with their unsurpassed properties, have been projected to dominate the μ-energy application space within the next several years. However, there are challenges that still need to be overcome to allow cost effective high volume manufacturing (HVM) of TFBs. Most critically, an alternative is needed to the current state-of-the-art TFB device patterning technology used during deposition of the device layers, namely shadow masks. There is significant complexity and cost associated with using shadow mask processes in HVM: (1) a significant capital investment is required in equipment for managing, precision aligning and cleaning the masks, especially for large area substrates; (2) there is poor utilization of substrate area due to having to accommodate deposition under shadow mask edges; and (3) there are constraints on the PVD processes—low power and temperature—in order to avoid thermal expansion induced alignment issues.

One of the common approaches to replace shadow masks is to use lithography technology, but this not only significantly increases cost, but also brings undesirable wet chemistries to the TFB fabrication flows and the potential layer and device performance degradation from the chemical and physical interaction between the TFB layer materials and the lithography chemicals, wet chemicals, and etching and dry-ash processes.

Clearly, there is a need for TFB structures and methods of manufacture that can significantly reduce the cost of HVM of TFBs by enabling simplified, more HVM-compatible TFB process technologies.

### SUMMARY

Some embodiments of the present disclosure relate to electrochemical devices such as thin film batteries (TFBs), methods of making the same and tools configured for carrying out the methods.

According to some embodiments, a thin film battery may comprise: a substrate; a cathode current collector layer and an anode current collector layer on the substrate, the cathode current collector layer and the anode current collector layer being electrically isolated from each other; a cathode layer on the cathode current collector layer, wherein a contact area of the cathode current collector layer is not covered by the cathode layer; an electrolyte layer completely covering the top surface of the cathode layer and covering a portion of the anode current collector layer, wherein the uncovered portion of the anode current collector is a contact area of the anode current collector; an anode layer on the electrolyte layer and the anode current collector, wherein a portion of the anode contact area of the anode current collector is not covered by the anode layer, and wherein an electrically insulating buffer area in the electrolyte layer, for electrically isolating the edge of the cathode layer adjacent to the contact area of the cathode current collector from the edge of the anode layer, is not covered by the anode layer, the electrically insulating buffer area being between the contact area of the cathode current collector layer and the anode layer.

According to some embodiments, a method of manufacturing thin film batteries may comprise: blanket depositing on a substrate a current collector layer and a cathode layer; laser die patterning the current collector layer and the cathode layer to form a cathode current collector and an anode current collector and laser ablating portions of the cathode layer to reveal a contact area of the cathode current collector and to expose all of the anode current collector, to form a first patterned stack; blanket depositing an electrolyte layer over the first patterned stack; laser ablating a portion of the electrolyte layer to expose a contact area of the anode current collector, to form a second patterned stack; blanket depositing an anode layer and an initial protection layer over the second patterned stack; laser die patterning the electrolyte, the anode and the initial protection layers within the die pattern of the laser die patterning of the current collector layer and the cathode layer; laser ablating portions of the initial protection, the anode, and the electrolyte layers to reveal the contact area of the cathode current collector, and laser ablating the initial protection layer, the anode layer and a portion of the thickness of the electrolyte layer to form an electrically insulating buffer area in the electrolyte layer to electrically isolate the laser cut edge of the cathode layer adjacent to the contact area of the cathode current collector from the laser cut edge of the patterned anode, and laser ablating a portion of the initial protection layer and the electrolyte layer to reveal the contact area of the anode current collector, to form a third device stack.

According to some embodiments, an apparatus for manufacturing thin film batteries on a substrate may comprise: a first system for blanket depositing on a substrate a current collector layer and a cathode layer and laser die patterning the current collector layer and the cathode layer to form a cathode current collector and an anode current collector and laser ablating portions of the cathode layer to reveal a contact area of the cathode current collector and to expose all of the anode current collector, to form a first patterned stack; a second system for blanket depositing an electrolyte layer over the first patterned stack and laser ablating a portion of the electrolyte layer to expose a contact area of the anode current collector, to form a second patterned stack; a third system for blanket depositing an anode layer and an initial protection layer over the second patterned stack, laser die patterning the electrolyte, the anode and the initial protection layers within the die pattern of the laser die patterning of the current collector layer and the cathode layer, laser ablating portions of the initial protection, the anode, and the electrolyte layers to reveal the contact area of the cathode current collector, laser ablating the initial protection layer, the anode layer and a portion of the thickness of the electrolyte layer to form an electrically insulating buffer area in the electrolyte layer to electrically isolate the laser cut edge of the cathode layer adjacent to the contact area of the cathode current collector from the laser cut edge of the patterned anode, and laser ablating a portion of the initial protection layer and the electrolyte layer to reveal the contact area of the anode current collector, to form a third device stack.

### BRIEF DESCRIPTION OF THE DRAWINGS

These and other aspects and features of the present disclosure will become apparent to those ordinarily skilled in the art upon review of the following description of specific embodiments in conjunction with the accompanying figures, wherein:

FIG. 1 is a cross-sectional representation of a stack of device layers for a thin film battery;

FIG. 2 is a cross-sectional representation of the thin film battery of FIG. 1 after conventional laser die patterning;

FIG. 3 is a cross-sectional representation of the thin film battery of FIG. 2 after a conventional laser process for revealing the cathode current collector for making device-side electrical contact;

FIGS. 4-9 are cross-sectional representations of sequential steps in a first process flow for fabrication of a TFB with a non-conductive substrate, according to some embodiments;

FIGS. 10-15 are cross-sectional representations of sequential steps in a second process flow for fabrication of a TFB with a non-conductive substrate, according to further embodiments;

FIGS. 16-21 are cross-sectional representations of sequential steps in a process flow for fabrication of a TFB with a conductive substrate, according to some embodiments;

FIG. 22 is a plan view of a substrate with 12 TFBs prior to dicing, showing TFBs with cathode areas in excess of 90% of the TFB footprint (device area) and showing an example TFB configuration corresponding to the process flows of FIGS. 4-9 and 10-15, according to some embodiments;

FIG. 23 is a plot of optical constants of LiPON material;

FIGS. 24A & B are plots of ablation depth as a function of laser fluence for ablation of 1.5 microns of LiPON by a 248 nm laser and 0.7/1.8 microns of Cu/LiPON by a 513 nm fs laser, respectively;

FIG. 25 is a schematic of a selective laser patterning tool, according to some embodiments;

FIG. 26 is a schematic illustration of a thin film deposition cluster tool for TFB fabrication, according to some embodiments;

FIG. 27 is a representation of a thin film deposition system with multiple in-line tools for TFB fabrication, according to some embodiments;

FIG. 28 is a representation of an in-line deposition tool for TFB fabrication, according to some embodiments;

FIGS. 29-36 are cross-sectional representations of sequential steps in a third process flow for fabrication of a TFB with a non-conductive substrate, according to some embodiments;

FIG. 37 is a plan view of a substrate with 12 coplanar TFBs prior to dicing, showing an example TFB configuration corresponding to the process flow of FIGS. 29-36, according to some embodiments; and

FIG. 38 is a plan view of a substrate with 12 TFBs prior to dicing, showing an example TFB configuration corresponding to the process flow of FIGS. 16-21, according to some embodiments.

### DETAILED DESCRIPTION

Embodiments of the present disclosure will now be described in detail with reference to the drawings, which are provided as illustrative examples of the disclosure so as to enable those skilled in the art to practice the disclosure. Notably, the figures and examples below are not meant to limit the scope of the present disclosure to a single embodiment, but other embodiments are possible by way of interchange of some or all of the described or illustrated elements. Moreover, where certain elements of the present disclosure can be partially or fully implemented using known components, only those portions of such known components that are necessary for an understanding of the present disclosure will be described, and detailed descriptions of other portions of such known components will be omitted so as not to obscure the disclosure. In the present disclosure, an embodiment showing a singular component should not be considered limiting; rather, the disclosure is intended to encompass other embodiments including a plurality of the same component, and vice-versa, unless explicitly stated otherwise herein. Moreover, it is not intended for any term in the present disclosure to be ascribed an uncommon or special meaning unless explicitly set forth as such. Further, the present disclosure encompasses present and future known equivalents to the known components referred to herein by way of illustration.

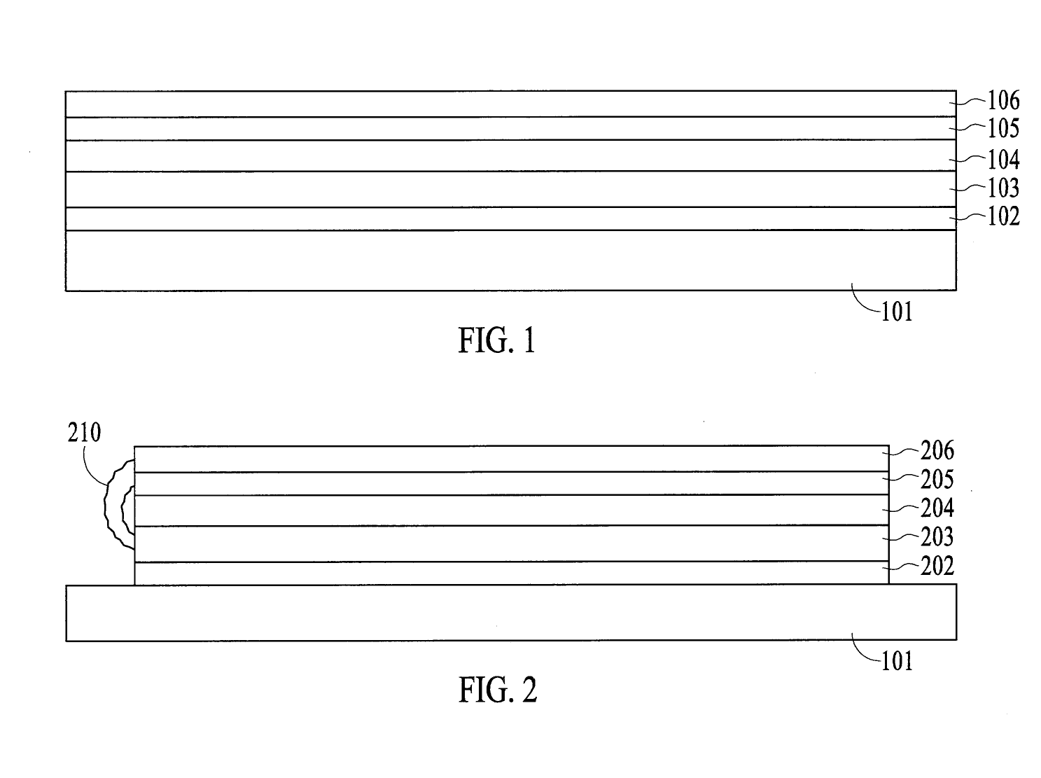

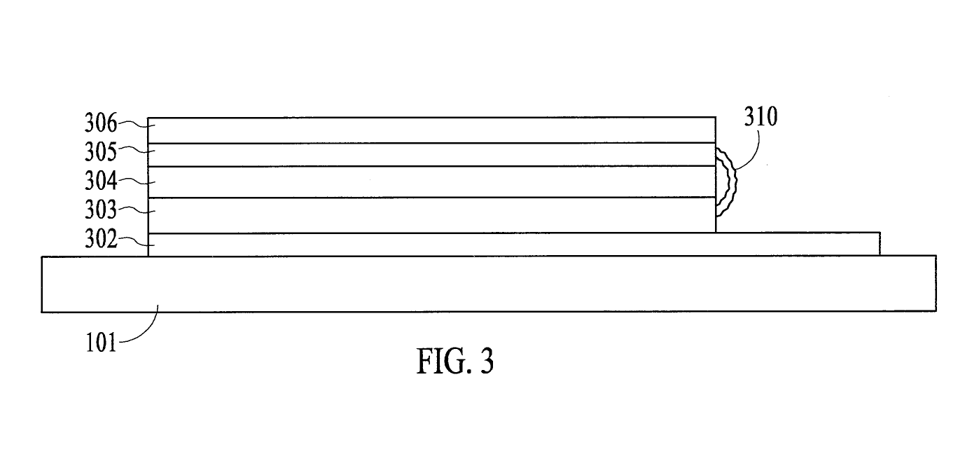

FIG. 1 shows a conventional stack of device layers for a TFB formed on a substrate 101, including blanket deposited: current collector layer 102 (e.g. Ti/Au), cathode layer 103 (e.g. LiCoO₂), electrolyte layer 104 (e.g. LiPON), anode layer 105 (e.g. Li, Si) and ACC/initial protection layer 106 (e.g. Cu, Ti/Cu). According to conventional processes, the stack of FIG. 1 then undergoes laser die-patterning to form the structure shown in FIG. 2, where layers 202-206 are the patterned equivalents of layers 102-106, respectively. However, as indicated in FIG. 2, there is a high probability of having electrical shorting paths 210 between the cathode/CCC 202/203 and anode/ACC 205/206 along the laser die patterned sidewall, which significantly affects manufacturing yields. Next, according to conventional processes the stack is further processed to expose the CCC layer 302 for making electrical contact, as shown in FIG. 3, where layers 302-306 are the patterned equivalents of layers 202-206, respectively; this process utilizes controlled laser exposure, by controlling scan speeds (spot laser)/number of shots (area laser) and fluence, to remove the stack down to the CCC layer 302, thus forming a step. Further to the aforementioned potential shorting issues, there is now a high probability of having short paths between cathode/CCC 302/303 and anode/ACC 305/306 along the CCC patterning sidewall as well, as indicated in FIG. 3, which also significantly affects manufacturing yield.

As described above with reference to FIGS. 1-3, a one-step laser die patterning process tends to create electrical shorting paths along the sidewall of the cathode/CCC and anode/ACC, and dramatically reduces battery performance and yield. However, by using two-step laser die patterning processes as disclosed in embodiments herein, electrical shorting paths along the sidewall of the cathode/CCC and the anode/ACC are unlikely to be created since the cathode/CCC has already been removed during the first die patterning process and is not ablated during the second die patterning process when the anode/ACC is patterned. This significantly increases manufacture yield and reduces battery leakage coming from the laser die patterning process. Regarding the CCC layer exposure/reveal process by laser ablation, the ACC, anode and electrolyte layers are completely removed to expose/reveal the CCC contact area. In general, the ACC and anode layers are conductive or semi-conductive materials and certain residuals of these layers are left on the surfaces in the ablation area even if femtosecond lasers are used for the ablation process. These ACC and anode residuals are likely to create electrical shorting paths from the ACC/anode to the cathode/CCC along the laser-cut sidewall. However, by including a narrow buffer area in the TFB device layout where the laser ablation process stops part way through the thickness of the insulating electrolyte layer, the likelihood of electrical shorting between the CCC/cathode and the anode/ACC is significantly reduced or even eliminated, thus making the fabrication of TFB devices by laser ablation patterning processes a viable proposition for manufacturing. Blanket depositions and ex situ laser pattering of TFBs actually improve pattern accuracy, yields and substrate/material usages, and have great potential to drive down the manufacturing costs of TFBs.

In more detail, some embodiments of TFBs of the present disclosure have fabrication processes which avoid the shortcomings of the prior art devices described above, these processes comprise: a two-step die patterning process which significantly reduces the likelihood of forming electrical shorting paths between the CCC/cathode and the anode/ACC along the laser-cut sidewall, the two-step process including a first die patterning process performed after CCC and cathode depositions, and a second die patterning process performed inside the first die patterning area after all active layer depositions have been completed; and in certain embodiments may also comprise use of nanosecond/picosecond lasers or femtosecond lasers (including UV wavelengths for all of these lasers) to create an electrically insulating electrolyte buffer area which electrically isolates the laser cut edge of the patterned CCC/cathode from the laser cut edge of the patterned anode/ACC where the laser cut edges are in close proximity (significantly decreasing the likelihood of electrical shorting between the CCC/cathode and the anode/ACC along the laser cut sidewall). Furthermore, in some embodiments, the die patterning process may be configured to allow the cathode layer to be patterned—removed to reveal the CCC below—before the cathode is annealed. Note that after high temperature annealing (at greater than 600° C.), the CCC materials—typically Ti and Au—tend to mix/alloy together which not only impairs the adhesion of the CCC to the substrate, but also reduces the optical reflectivity at the laser wavelengths used for the laser ablation process. These two effects cause difficulties for selectively ablating away LiCoO₂ from the CCC without significantly damaging the CCC. In addition, the LiCoO₂ layer after high temperature annealing requires a higher laser fluence to ablate the layer compared with ablation prior to annealing. Consequently, a process flow in which the cathode is annealed after patterning is advantageous from the perspectives of maintaining good CCC adhesion to the substrate and also allowing for an easier ablation process.

Furthermore, the laser processing and ablation patterns of the embodiments described herein may be designed to form TFBs with very similar device structures to those fabricated using masks, although more accurate edge placement may provide higher device densities and other design improvements. Higher yield and device density for TFBs over current shadow mask manufacturing processes are expected for some embodiments of processes since using shadow masks in TFB fabrication processes is a likely source of yield killing defects and removing the shadow masks may remove these defects. It is also expected that some embodiments of processes will provide better patterning accuracy than for shadow mask processes, which will allow higher TFB device densities on a substrate. Further, some embodiments of processes are expected to relax constraints on PVD processes (restricted to lower power and temperature in shadow mask deposition processes) caused by potential thermal expansion induced alignment issues of the shadow masks, and thus increase deposition rates of TFB layers. Furthermore, taking shadow masks out of the TFB manufacturing process may reduce new manufacturing process development costs by: eliminating mask aligner, mask management systems and mask cleaning; CoC (cost of consumables) reduction; and allowing use of industry proven processes—from the silicon integrated circuit and display industries. Blanket layer depositions and ex-situ laser pattering of TFB may improve pattern accuracy, yields and substrate/material usages sufficiently to drive down the TFB manufacturing costs—perhaps even a factor of 10 or more less than 2014 estimated costs.

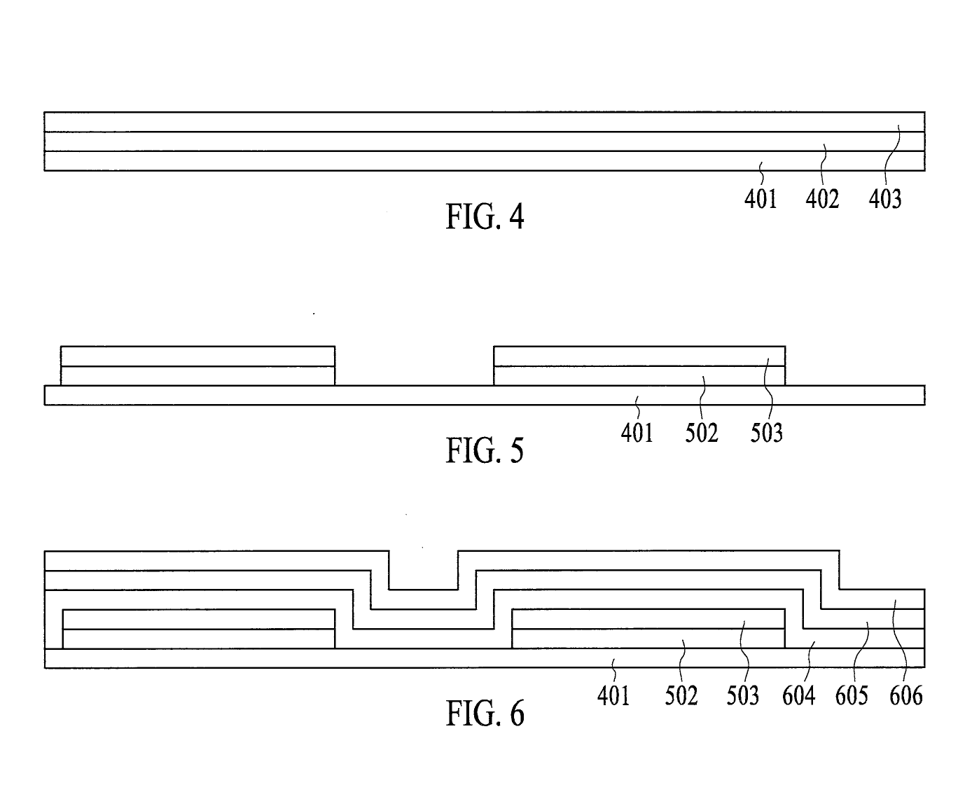

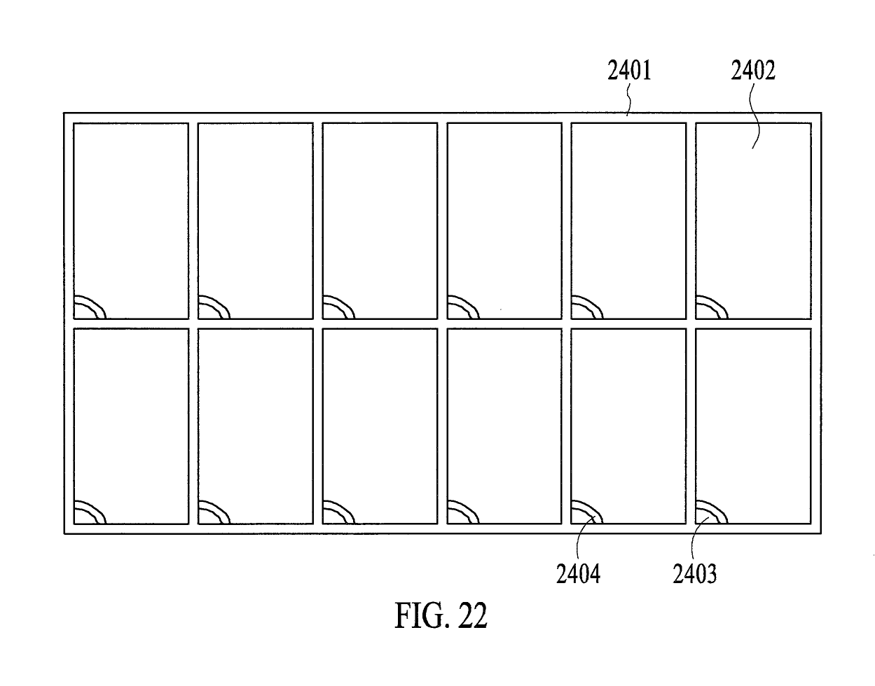

In conventional TFB manufacturing all layers are patterned using in-situ shadow masks which are fixed to the device substrate by sub-carriers, backside magnets, etc. In the present disclosure, instead of in-situ patterned depositions, blanket depositions without any shadow mask are proposed for all layers in the TFB fabrication process (see FIGS. 4-9, 10-15, 16-21 and 29-36), or for certain layers such as one or more of current collectors, cathode, electrolyte and anode. The flow may also incorporate processes for bonding, encapsulation and/or protective coating. Patterning of the blanket layers is by (1) a laser ablation process that removes all layers down to the substrate, and/or (2) a selective laser ablation process, where the laser patterning process removes a layer or stack of layers while leaving layer(s) below at least partially intact. For example, according to some embodiments, a cathode current collector and cathode are first blanket deposited on a substrate, A laser process is then used to pattern the whole blanket coated substrate into individual dies. Electrolyte, anode and anode current collector depositions are made over the die patterned layers after the first laser patterning. The substrate is then loaded into a laser ablation system once again to perform die patterning and CCC exposure—the second die patterning is made inside the first die patterning area, in other words the first die patterning is to completely remove CCC/cathode material along dicing alleys and the second die patterning is to completely remove electrolyte, anode and ACC inside the first dicing area. The CCC exposure/reveal is performed at one corner of each TFB die in order to maximize the cathode area and thus substrate area utilization—see FIG. 22. By adjusting the laser process parameters such as fluence and number of shots, ACC, anode, electrolyte and cathode are selectively removed to expose/reveal the CCC contact area. In order to avoid electrical shorting paths between CCC/cathode and ACC/anode, a narrow buffer area may be used between the CCC exposure/reveal area and the ACC/anode area. In this narrow buffer area, the laser ablation process is intended just to remove the ACC, the anode and a small portion of the electrolyte. Note that for TFBs, LiPON is typically used as the electrolyte and it is almost transparent from UV to long visible wavelengths, thus in order to stop the laser ablation process in the middle of the LiPON layer, nanosecond/picosecond or femtosecond lasers (including UV wavelengths for all of these lasers) are used. The width of the narrow buffer area is typically in the range of roughly 30 microns to roughly 200 microns.

For TFBs, an example of a cathode layer is a LiCoO₂ layer (deposited by e.g. RF sputtering, pulsed DC sputtering, etc.), of an anode layer is a Li metal layer (deposited by e.g. evaporation, sputtering, etc.), and of an electrolyte layer is a LiPON layer (deposited by e.g. RF sputtering, etc.), However, it is expected that the present disclosure may be applied to a wider range of TFBs comprising different materials. Furthermore, deposition techniques for these layers may be any deposition technique that is capable of providing the desired composition, phase and crystallinity, and may include deposition techniques such as PVD, PECVD, reactive sputtering, non-reactive sputtering, RF sputtering, multi-frequency sputtering, electron and ion beam evaporation, thermal evaporation, CVD, ALD, etc.; the deposition method can also be non-vacuum based, such as plasma spray, spray pyrolysis, slot die coating, screen printing, etc. For a PVD sputter deposition process, the process may be AC, DC, pulsed DC, RF, HF (e.g., microwave), etc., or combinations thereof. Examples of materials for the different component layers of a TFB may include one or more of the following. The substrate may be silicon, silicon nitride on Si, glass, PET (polyethylene terephthalate), mica, metal foils such as copper, etc. The ACC and CCC may be one or more of Ag, Al, Au, Ca, Cu, Co, Sn, Pd, Zn and Pt which may be alloyed and/or present in multiple layers of different materials and/or include Ti adhesion layers, etc. The cathode may be LiCoO₂, V₂O₅, LiMnO₂, Li₅FeO₄, NMC (NiMnCo oxide), NCA (NiCoAl oxide), LMO (LiₓMnO₂), LFP (LiₓFePO₄), LiMn spinel, etc. The solid electrolyte may be a lithium-conducting electrolyte material including materials such as LiPON, LiI/Al₂O₃ mixtures, LLZO (LiLaZr oxide), LiSiCON, Ta₂O₅, etc. The anode may be Li, Si, silicon-lithium alloys, lithium silicon sulfide, Al, Sn, C, etc.

The anode/negative electrode layer may be pure lithium metal or may be a Li alloy, where the Li is alloyed with a metal such as tin or a semiconductor such as silicon, for example. The Li layer can be about 3 μm thick (as appropriate for the cathode and capacity balancing) and the encapsulation layer can be 3 μm or thicker. The encapsulation layer can be a multilayer of parylene and metal and/or dielectric. Note that, between the formation of the Li layer and the encapsulation layer, the part must be kept in an inert environment, such as argon gas; however, after blanket encapsulation layer deposition the requirement for an inert environment will be relaxed. The ACC may be used to protect the Li layer allowing laser ablation outside of vacuum and the requirement for an inert environment may be relaxed.

Furthermore, the metal current collectors, both on the cathode and anode side, may need to function as protective barriers to the shuttling lithium ions. In addition, the anode current collector may need to function as a barrier to oxidants (e.g. H₂O, O₂, N₂, etc.) from the ambient. Therefore, the material or materials of choice should have minimal reaction or miscibility in contact with lithium in “both directions”—i.e., the Li moving into the metallic current collector to form a solid solution and vice versa. In addition, the material choice for the metallic current collector should have low reactivity and diffusivity to those oxidants. Based on published binary phase diagrams, some potential candidates for the first requirements are Ag, Al, Au, Ca, Cu, Co, Sn, Pd, Zn and Pt. With some materials, the thermal budget may need to be managed to ensure there is no reaction/diffusion between the metallic layers. If a single metal element is incapable of meeting both requirements, then alloys may be considered. Also, if a single layer is incapable of meeting both requirements, then dual (multiple) layers may be used. Furthermore, in addition an adhesion layer may be used in combination with a layer of one of the aforementioned refractory and non-oxidizing layers—for example, a Ti adhesion layer in combination with Au. The current collectors may be deposited by (pulsed) DC sputtering of metal targets (approximately 300 nm) to form the layers (e.g., metals such as Cu, Ag, Pd, Pt and Au, metal alloys, metalloids or carbon black). Furthermore, there are other options for forming the protective barriers to the shuttling lithium ions, such as dielectric layers, etc.

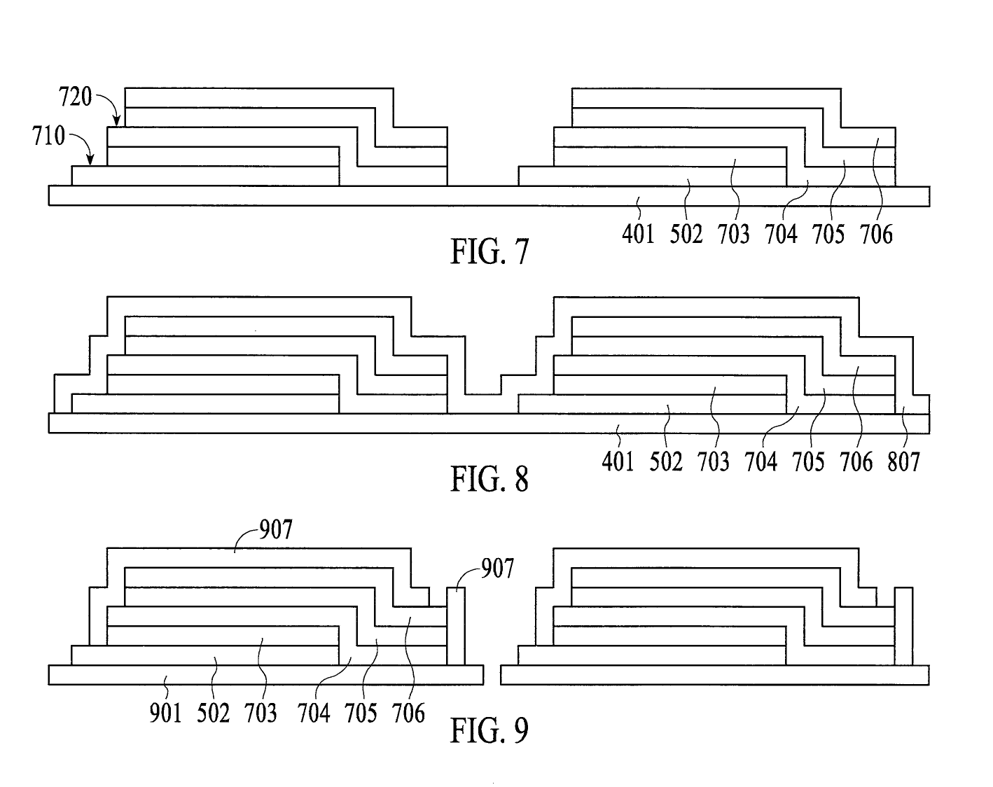

FIGS. 4-9 illustrate the fabrication process for a TFB according to some embodiments—this is a first process flow for a non-conductive substrate. The process flow starts in FIG. 4 with blanket depositions on a substrate 401 of a current collector layer 402 (e.g. Ti/Au) and a cathode layer 403 (e.g. LiCoO₂). The non-conductive substrate may be glass, ceramic, rigid material, flexible material, plastic/polymer, etc.; furthermore, in embodiments for which laser patterning is done from the substrate side of the TFB the substrate will also need to meet the transparency requirements for laser processing. FIG. 5 shows the structure of FIG. 4 after the following processing: (1) laser die patterning from substrate or thin film side; and (2) cathode annealing, which for LiCoO₂, for example, may be an anneal at 600° C. or more for 2 hours or more in order to develop a crystalline structure, where layers 502 and 503 are the processed current collector and cathode layers, respectively. FIG. 6 shows the structure of FIG. 5 after blanket deposition of an electrolyte (e.g. LiPON) layer 604 and anode (e.g. Li, Si) layer 605, and ACC/initial protection (e.g. Ti/Cu) layer(s) 606. Also, dry lithiation can be done, before the electrolyte deposition, if needed at this point in the process—for example, when fabricating non-Li anode cells, where the cell uses charge carriers from the original cathode without separately deposited Li anode. FIG. 7 shows the structure of FIG. 6 after the following further processing: (1) second die patterning using a laser patterning process; and (2) CCC exposure including forming a buffer area 720 where the laser ablation is stopped at the insulating electrolyte layer, which may be formed using sub-UV lasers (e.g., 248 nm or 266 nm) or fs lasers to increase the length of the electrical shorting path, and thus reduce the probability of occurrence of shorting, between the CCC/cathode and the anode/ACC along the laser cut sidewall. Layers 704, 705 and 706 are processed layers 604, 605 and 606, respectively, and 710 is the CCC electrical contact area. FIG. 8 shows the structure of FIG. 7 after blanket encapsulation (e.g. polymer, dielectric layer) layer 807 depositions—multiple layers may be deposited, if needed to provide the required device longevity, for example multiple layers of polymer/dielectric/metal. FIG. 9 shows the structure of FIG. 8 after laser ablations to expose the CCC and ACC contact areas—opened up to enable electrical contact to be made to the TFB electrodes—both ACC and CCC. Layer 907 is the processed layer 807, and 901 is the substrate for a single TFB. Furthermore, in some embodiments the deposition and patterning of an encapsulation layer, as shown in FIGS. 8 & 9, may be repeated one or more times using the same or different encapsulation materials. Laser ablation may also be used for die singulation.

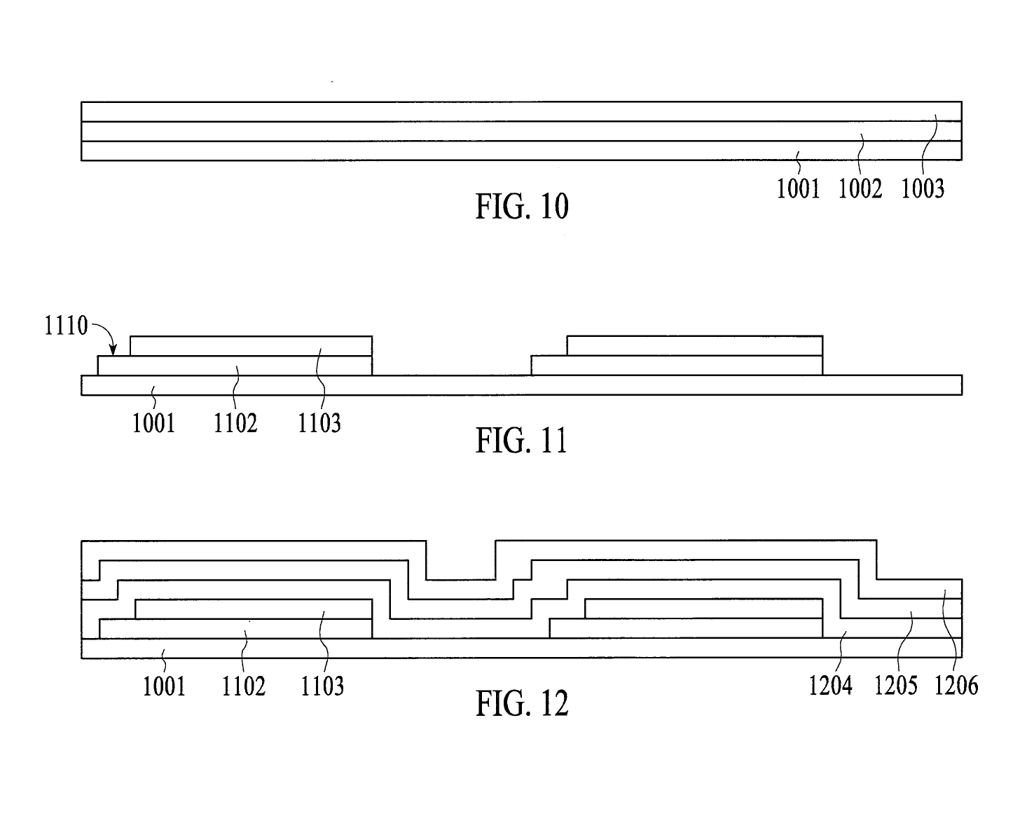

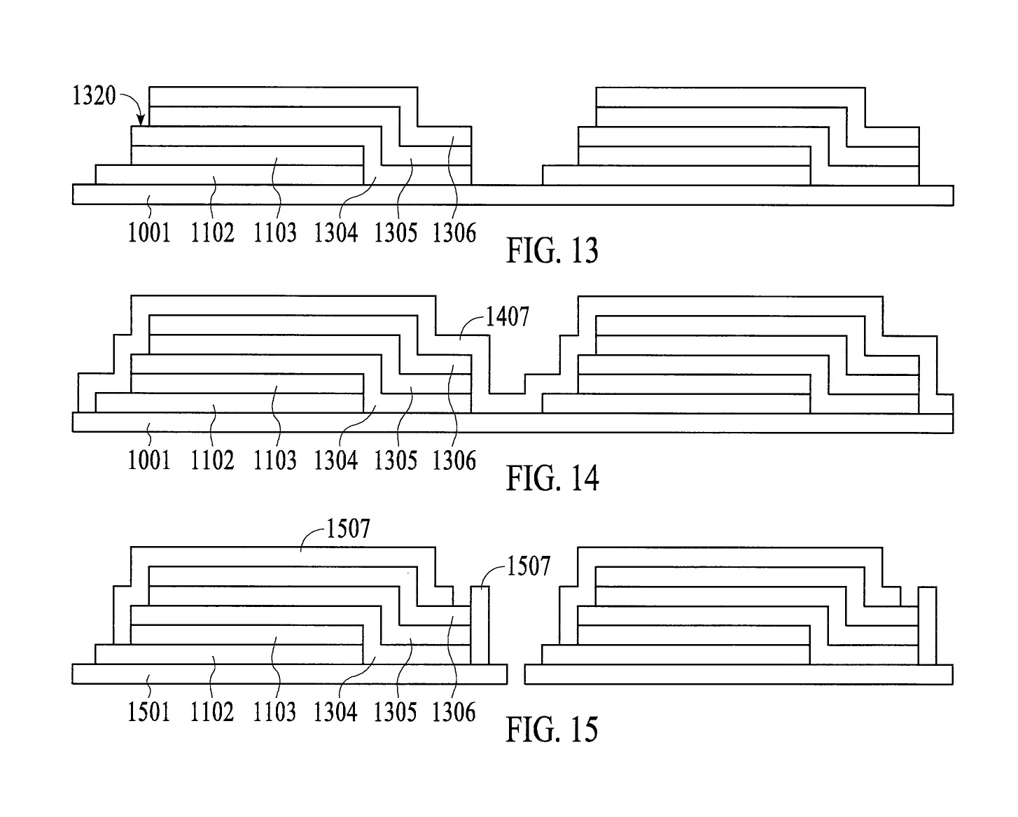

FIGS. 10-15 illustrate the fabrication process for a TFB according to some embodiments—this is a second process flow for a non-conductive substrate 1001. The process flow starts in FIG. 10 with blanket depositions on a substrate 1001 of a current collector (e.g. Ti/Au) layer 1002 and a cathode (e.g. LiCoO₂) layer 1003. The non-conductive substrate may be glass, ceramic, rigid material, flexible material, plastic/polymer, etc.; furthermore, in embodiments for which laser patterning is done from the substrate side of the TFB the substrate will also need to meet the transparency requirements for laser processing. FIG. 11 shows the structure of FIG. 10 after the following processing: (1) laser die patterning from substrate or thin film side; (2) CCC layer exposure/reveal before cathode annealing (the reason for this processing sequence is that laser ablation of an un-annealed cathode generally produces a better ablation surface—higher conductivity and smoother surface morphology—also see discussion above); and (3) cathode annealing, which for LiCoO₂, for example, may be an anneal at 600° C. or more for 2 hours or more in order to develop a crystalline structure. Layers 1102 and 1103 are the processed current collector and cathode layers, respectively, and 1110 is the CCC electrical contact area. FIG. 12 shows the structure of FIG. 11 after blanket deposition of an electrolyte (e.g. LiPON) layer 1204 and anode (e.g. Li, Si) layer 1205, and ACC/initial protection (e.g. Ti/Cu) layer(s) 1206. Also, dry lithiation can be done, before the electrolyte deposition, if needed at this point in the process—for example, when fabricating non-Li anode cells, where the cell uses charge carriers from the original cathode without separately deposited Li anode. FIG. 13 shows the structure of FIG. 12 after the following further processing: (1) second die patterning using a laser patterning process; and (2) CCC step exposure/reveal including forming a buffer area 1320 where the laser ablation is stopped at the insulated electrolyte layer, which may be formed using sub-UV lasers (e.g., 248 nm or 266 nm) or fs lasers to increase the length of the potential electrical shorting path, and thus reduce the probability of occurrence of shorting, between the CCC/cathode and the anode/ACC along the laser cut sidewall. Layers 1304, 1305 and 1306 are processed layers 1204, 1205 and 1206, respectively. FIG. 14 shows the structure of FIG. 13 after blanket encapsulation (e.g. polymer, dielectric layer) layer 1407 depositions—multiple layers may be deposited, if needed to provide the required device longevity, for example multiple layers of polymer/dielectric/metal. FIG. 15 shows the structure of FIG. 14 after laser ablations to expose the CCC and ACC contact areas—opened up to enable electrical contact to be made to the TFB electrodes—both ACC and CCC. Layer 1507 is the processed layer 1407, and 1501 is the substrate for a single TFB. Furthermore, in some embodiments the deposition and patterning of an encapsulation layer, as shown in FIGS. 14 & 15, may be repeated one or more times using the same or different encapsulation materials. Laser ablation may also be used for die singulation.

FIG. 22 is a plan view of a substrate 2401 with 12 TFBs prior to dicing, showing TFBs with cathode areas in excess of 90% of the TFB footprint (device area); furthermore, note that the anode should be equal to or slightly larger than the cathode. The figure shows anode 2402, exposed part 2403 of the CCC, and electrolyte buffer area 2404, where the buffer area has been formed by stopping the laser ablation process in the middle of the LiPON layer. Note that the contact area 2403 is not restricted to the corners as shown in the figure, but may be placed in other positions on the CCC, and that a contact area may be opened through the encapsulation layer to the ACC anywhere on the surface of the ACC. The configuration of FIG. 22 is an example of a device configuration for some embodiments of the devices resulting from the fabrication processes of both FIGS. 4-9 and FIGS. 10-15.

According to some embodiments, such as shown in FIGS. 9, 15 and 22, a thin film battery may comprise: a substrate; a cathode current collector layer on the substrate; a cathode layer on the cathode current collector layer, wherein a contact area of the cathode current collector layer is not covered by the cathode layer; an electrolyte layer completely covering the top surface of the cathode layer, wherein the contact area of the cathode current collector layer is not covered by the electrolyte layer; an anode layer on the electrolyte layer, wherein the contact area of the cathode current collector layer is not covered by the anode layer, and wherein an electrically insulating buffer area in the electrolyte layer, for electrically isolating the edge of the cathode layer adjacent to the contact area of the cathode current collector from the edge of the anode layer, is not covered by the anode layer, the electrically insulating buffer area being between the contact area of the cathode current collector layer and the anode layer. The thin film battery may further comprise an anode current collector layer on the surface of the anode layer, wherein the contact area of the cathode current collector layer and the electrically insulating buffer area are not covered by the anode current collector layer. Furthermore, the contact area of the cathode current collector may be a corner portion of the top surface of the cathode current collector layer. The thin film battery may further comprise an encapsulation layer, the encapsulation layer being on the top surface of the anode current collector layer and covering the complete top surface of the anode current collector layer, apart from an anode current collector contact area, the encapsulation layer further covering the electrically insulating buffer area and a portion of the contact area of the cathode current collector layer.

According to embodiments, such as shown in FIGS. 4-9 and 22, a method of manufacturing thin film batteries may comprise: blanket depositing on a substrate a cathode current collector layer followed by a cathode layer; laser die patterning the cathode current collector layer and the cathode layer to form a first patterned stack comprising a cathode covering the top surface of a cathode current collector; blanket depositing an electrolyte layer, an anode layer and an anode current collector layer over the first patterned stack; laser die patterning the anode current collector layer, the anode layer, and the electrolyte layer and laser ablating portions of the anode current collector layer, the anode layer, and the electrolyte layer to form a third stack, the third stack comprising an anode current collector covering the top surface of an anode, a revealed contact area of the cathode current collector and a revealed electrically insulating buffer area in the electrolyte layer to electrically isolate the laser cut edge of the cathode adjacent to the contact area of the cathode current collector from the laser cut edge of the anode, wherein a portion of the thickness of the electrolyte layer is ablated to form the electrically insulating buffer area. The method may further comprise annealing the cathode after the laser ablation of the cathode current collector layer and the cathode layer. The method may further comprise blanket depositing an encapsulation layer on the third stack, and laser ablating the encapsulation layer to reveal a portion of the contact area of the cathode current collector and a contact area of the anode current collector, to form a fourth device structure. The method may further comprise blanket depositing a second encapsulation layer on the fourth device stack and laser ablating portions of the second encapsulation layer to reveal a second portion of the contact area of the cathode current collector and a portion of the contact area of the anode current collector, wherein the second portion is smaller than the first portion. Furthermore, the laser ablating of the electrolyte layer to form the electrically insulating buffer area in the electrolyte layer may utilize a femtosecond UV laser.

According to embodiments, such as shown in FIGS. 10-15 and 22, a method of manufacturing thin film batteries may comprise: blanket depositing on a substrate a cathode current collector layer and a cathode layer; laser die patterning and laser ablation of the cathode current collector layer and said cathode layer to form a cathode on the top surface of a cathode current collector and laser ablating portions of the cathode layer to reveal a contact area of the cathode current collector, to form a first patterned stack; blanket depositing an electrolyte layer, an anode layer and an anode current collector layer over the first patterned stack; laser die patterning the anode current collector layer, the anode layer, and the electrolyte layer and laser ablating portions of the anode current collector layer, the anode layer, and the electrolyte layer to form a third stack, the third stack comprising an anode current collector covering the top surface of an anode, a revealed contact area of the cathode current collector and a revealed electrically insulating buffer area in the electrolyte layer to electrically isolate the laser cut edge of the cathode adjacent to the contact area of the cathode current collector from the laser cut edge of the anode, wherein a portion of the thickness of the electrolyte layer is ablated to form the electrically insulating buffer area. The method may further comprise annealing the cathode after the laser ablation of the cathode current collector layer and the cathode layer. The method may further comprise blanket depositing an encapsulation layer on the third stack, and laser ablating the encapsulation layer to reveal a portion of the contact area of the cathode current collector and a contact area of the anode current collector, to form a fourth device structure. The method may further comprise blanket depositing a second encapsulation layer on the fourth device stack and laser ablating portions of the second encapsulation layer to reveal a second portion of the contact area of the cathode current collector and a portion of the contact area of the anode current collector, wherein the second portion is smaller than the first portion. Furthermore, the laser ablating of the electrolyte layer to form the electrically insulating buffer area in the electrolyte layer may utilize a femtosecond UV laser.

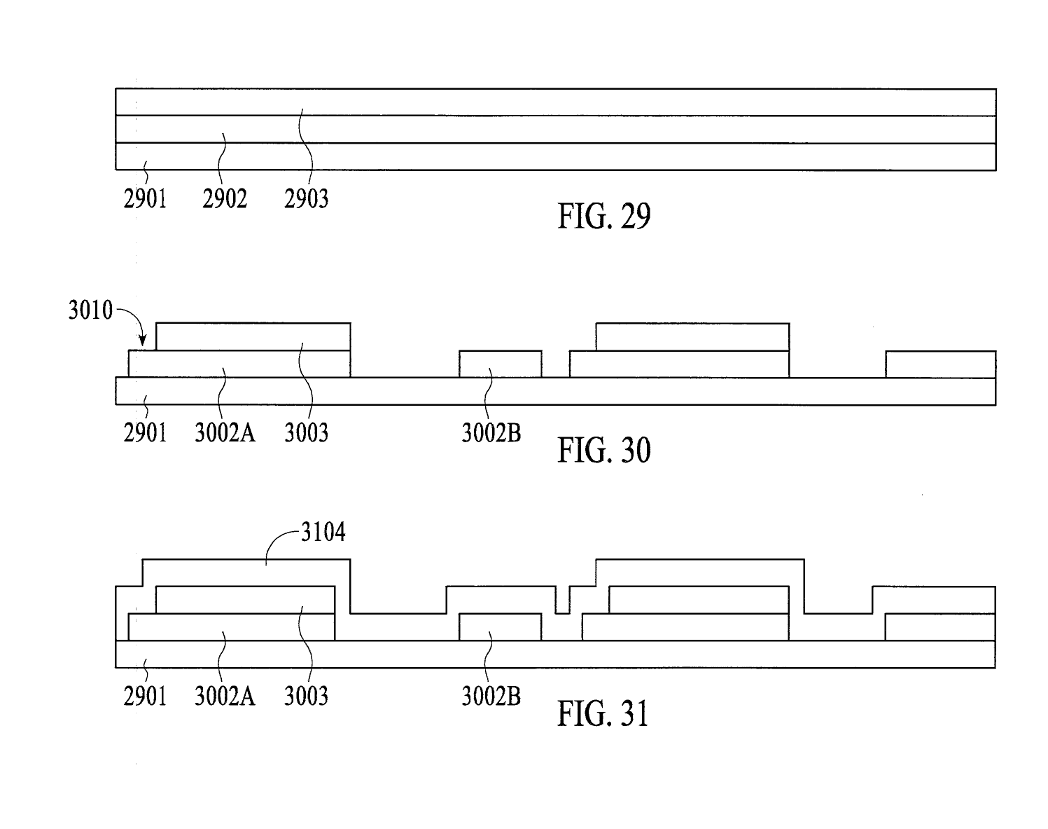

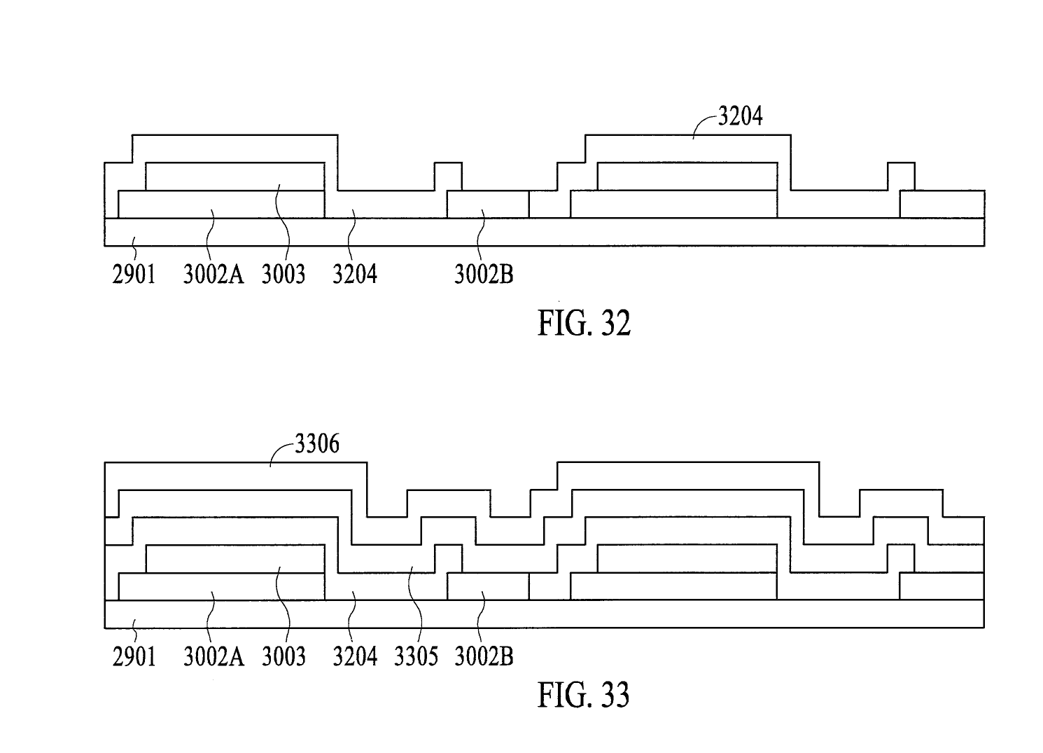

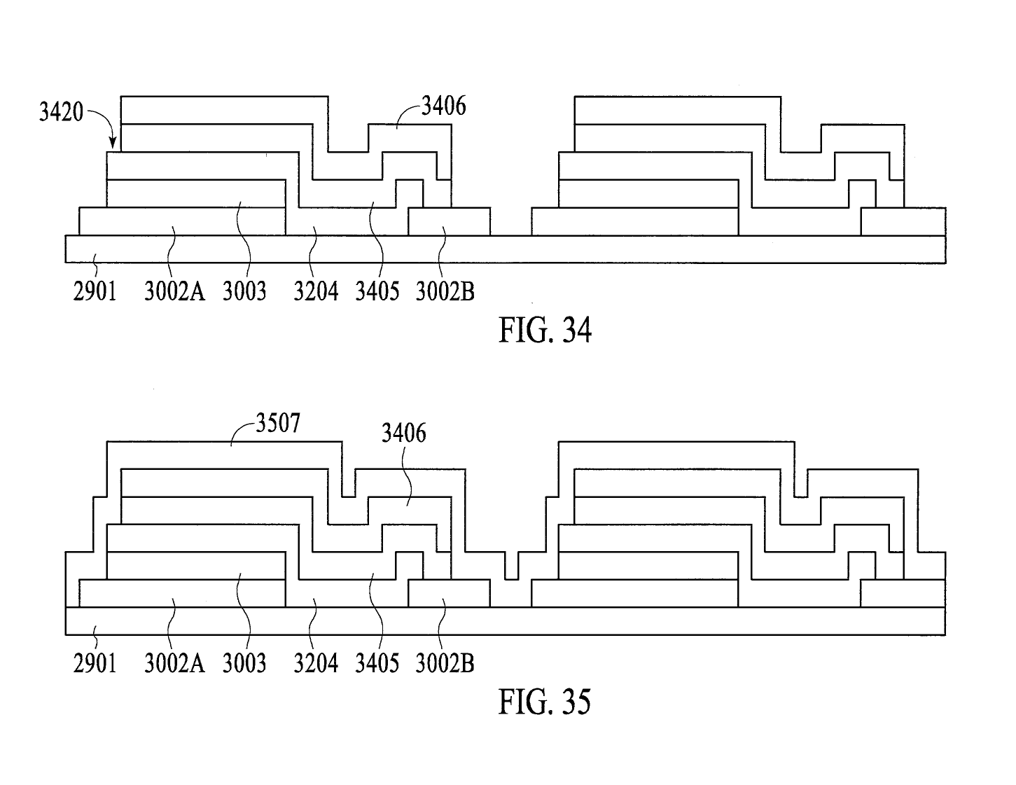

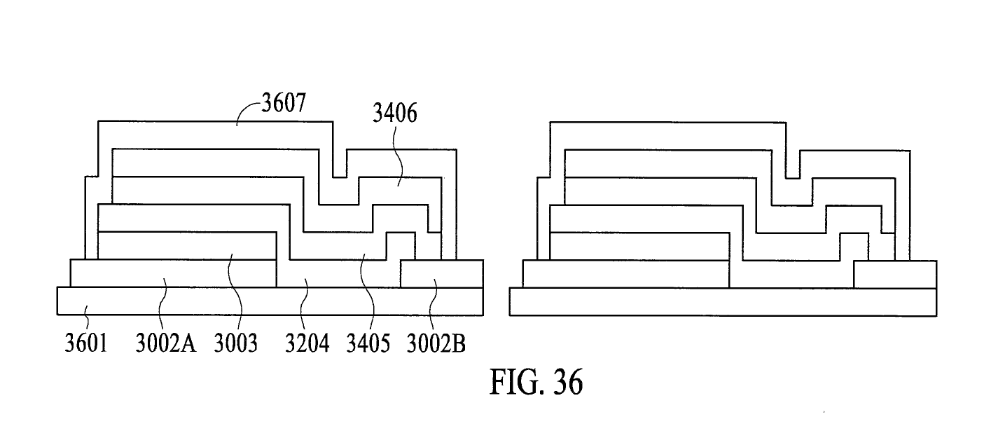

FIGS. 29-36 illustrate the fabrication process for a TFB according to some embodiments—this is a third process flow for a non-conductive substrate 2901. The process flow starts in FIG. 29 with blanket depositions on a substrate 2901 of a current collector (e.g. Ti/Au) layer 2902 and a cathode (e.g. LiCoO₂) layer 2903. The non-conductive substrate may be glass, ceramic, rigid material, flexible material, plastic/polymer, etc.; furthermore, in embodiments for which laser patterning is done from the substrate side of the TFB the substrate will also need to meet the transparency requirements for laser processing. FIG. 30 shows the structure of FIG. 29 after the following processing: (1) laser die patterning from substrate or thin film side; (2) CCC layer and ACC exposure/reveal before cathode annealing (the reason for this processing sequence is that laser ablation of an un-annealed cathode generally produces a better ablation surface—higher conductivity and smoother surface morphology—also see discussion above); and (3) cathode annealing, which for LiCoO₂, for example, may be an anneal at 600° C. or more for 2 hours or more in order to develop a crystalline structure. Layers 3002A and 3002B, respectively CCC layer and ACC layer, are the processed layer 2902, and 3003 is the processed cathode layer, and 3010 is the CCC electrical contact area. FIG. 31 shows the structure of FIG. 30 after blanket deposition of an electrolyte (e.g. LiPON) layer 3104. Also, dry lithiation can be done, before the electrolyte deposition, if needed at this point in the process—for example, when fabricating non-Li anode cells, where the cell uses charge carriers from the original cathode without separately deposited Li anode. FIG. 32 shows the structure of FIG. 31 after laser removal of electrolyte material from a majority of the surface of the ACC. Layer 3204 is the processed layer 3104. FIG. 33 shows the structure of FIG. 32 after blanket deposition of an anode (e.g. Li, Si) layer 3305 and initial protection (e.g. Ti/Cu) layer(s) 3306. FIG. 34 shows the structure of FIG. 33 after the following further processing: (1) second die patterning using a laser patterning process; and (2) CCC step exposure/reveal including forming a buffer area 3420 where the laser ablation is stopped at the insulated electrolyte layer, which may be formed using sub-UV lasers (e.g., 248 nm or 266 nm) or fs lasers to increase the length of the potential electrical shorting path, and thus reduce the probability of occurrence of shorting, between the CCC/cathode and the anode/ACC along the laser cut sidewall. Layers 3405 and 3406 are processed layers 3305 and 3306, respectively. FIG. 35 shows the structure of FIG. 34 after blanket encapsulation (e.g. polymer, dielectric layer) layer 3507 depositions—multiple layers may be deposited, if needed to provide the required device longevity, for example multiple layers of polymer/dielectric/metal. FIG. 36 shows the structure of FIG. 35 after laser ablations to expose the CCC and ACC contact areas—opened up to enable electrical contact to be made to the TFB electrodes—both ACC and CCC. Layer 3607 is the processed layer 3507, and 3601 is the substrate for a single TFB. Furthermore, in some embodiments the deposition and patterning of an encapsulation layer, as shown in FIGS. 35 & 36, may be repeated one or more times using the same or different encapsulation materials. Laser ablation may also be used for die singulation.

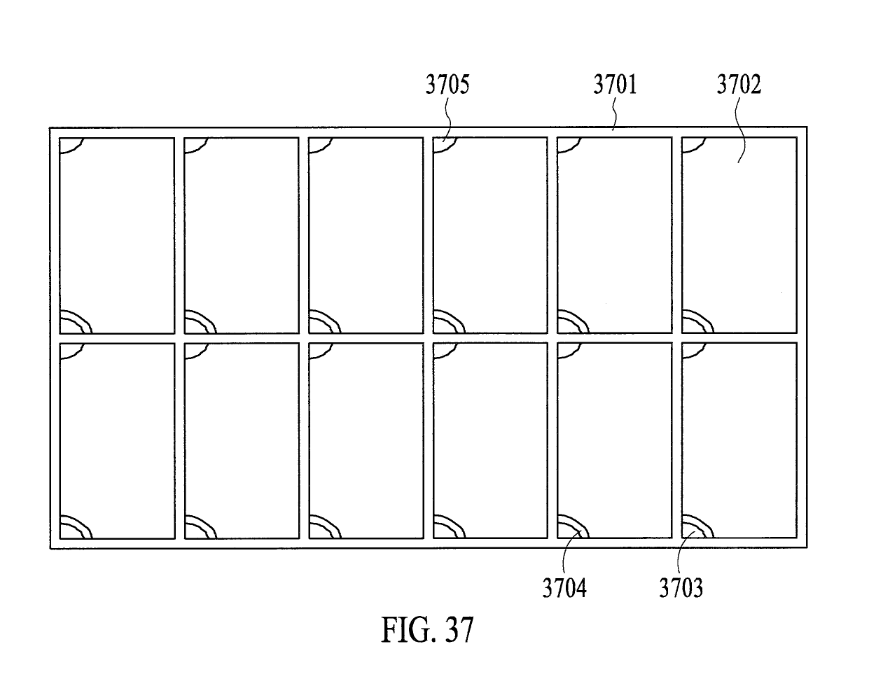

FIG. 37 is a plan view of a substrate 3701 with 12 coplanar TFBs prior to dicing, showing TFBs with anode areas in excess of 90% of the TFB footprint (device area). The figure shows the extent of the anode 3702 (underneath initial protection and encapsulation layers), exposed part 3703 of the CCC, electrolyte buffer area 3704 (underneath encapsulation layer), where the buffer area has been formed by stopping the laser ablation process in the middle of the LiPON layer, and exposed part 3705 of the ACC. Note that the contact areas 3703 and 3705 are not restricted to the corners as shown in the figure, but may be placed in other positions on the corresponding current collectors. The configuration of FIG. 37 is an example of a device configuration for some embodiments of the devices resulting from the fabrication processes of FIGS. 29-36.

According to embodiments, such as shown in FIGS. 36 and 37, a thin film battery may comprise: a substrate; a cathode current collector layer and an anode current collector layer on the substrate, the cathode current collector layer and the anode current collector layer being electrically isolated from each other; a cathode layer on the cathode current collector layer, wherein a contact area of the cathode current collector layer is not covered by the cathode layer; an electrolyte layer completely covering the top surface of the cathode layer and covering a portion of the anode current collector layer, wherein the uncovered portion of the anode current collector is a contact area of the anode current collector; an anode layer on the electrolyte layer and the anode current collector, wherein a portion of the anode contact area of the anode current collector is not covered by the anode layer, and wherein an electrically insulating buffer area in the electrolyte layer, for electrically isolating the edge of the cathode layer adjacent to the contact area of the cathode current collector from the edge of the anode layer, is not covered by the anode layer, the electrically insulating buffer area being between the contact area of the cathode current collector layer and the anode layer. Furthermore, the contact area of the cathode current collector may be a corner portion of the top surface of the cathode current collector. Furthermore, the contact area of the anode current collector may be a corner portion of the top surface of the anode current collector. The thin film battery may further comprise an initial protection layer, the initial protection layer being on the top surface of the anode layer and covering the complete top surface of the anode layer without extending beyond the edges of the anode layer. The thin film battery may further comprise an encapsulation layer completely covering the initial protection layer, the anode layer, the electrolyte layer, and the cathode layer.

According to some embodiments, such as shown in FIGS. 29-36 and 37, a method of manufacturing thin film batteries may comprise: blanket depositing on a substrate a current collector layer and a cathode layer; laser die patterning the current collector layer and the cathode layer to form a cathode current collector and an anode current collector and laser ablating portions of the cathode layer to reveal a contact area of the cathode current collector and to expose all of the anode current collector, to form a first patterned stack; blanket depositing an electrolyte layer over the first patterned stack; laser ablating a portion of the electrolyte layer to expose a contact area of the anode current collector, to form a second patterned stack; blanket depositing an anode layer and an initial protection layer over the second patterned stack; laser die patterning the electrolyte, the anode and the initial protection layers within the die pattern of the laser die patterning of the current collector layer and the cathode layer; laser ablating portions of the initial protection, the anode, and the electrolyte layers to reveal the contact area of the cathode current collector, and laser ablating the initial protection layer, the anode layer and a portion of the thickness of the electrolyte layer to form an electrically insulating buffer area in the electrolyte layer to electrically isolate the laser cut edge of the cathode layer adjacent to the contact area of the cathode current collector from the laser cut edge of the patterned anode, and laser ablating a portion of the initial protection layer and the electrolyte layer to reveal the contact area of the anode current collector, to form a third device stack. Furthermore, the cathode layer may be annealed after the laser die patterning of the current collector layer and the cathode layer and the laser ablating of the portions of the cathode layer. Furthermore, an encapsulation layer may be blanket deposited on the third device stack, and the encapsulation layer may be laser ablated to reveal a portion of the contact area of the cathode current collector and a portion of the contact area of the anode current collector, to form a fourth device structure. Furthermore, a second encapsulation layer may be blanket deposited on the fourth device stack, and the second encapsulation layer may be laser ablated to reveal a second portion of the contact area of the cathode current collector and a second portion of the contact area of the anode current collector, wherein the second portion is smaller than the first portion. Furthermore, the laser ablating the electrolyte layer to form the electrically insulating buffer area in the electrolyte layer may utilize a femtosecond UV laser.

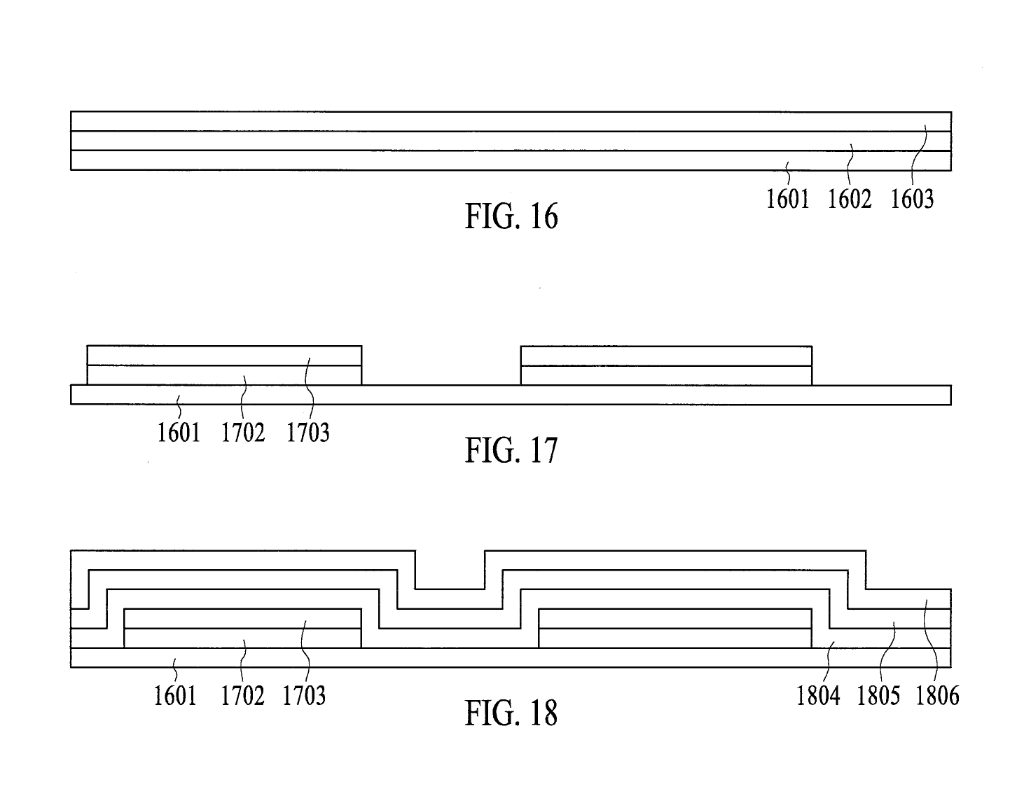

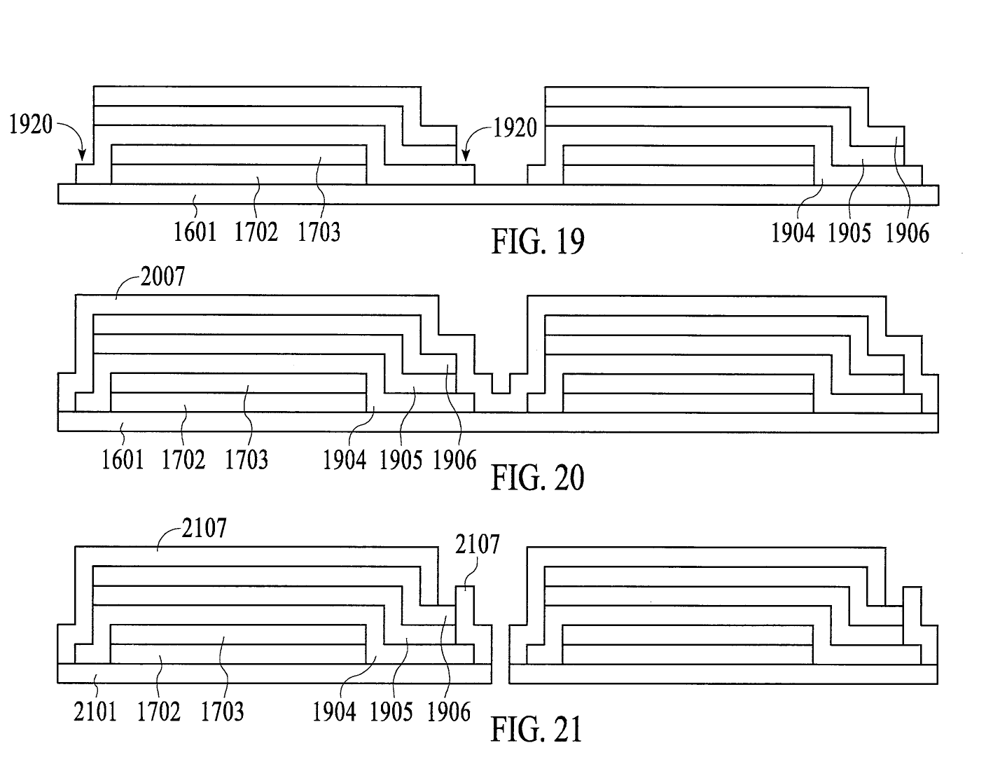

FIGS. 16-21 illustrate the fabrication process for a TFB according to some embodiments—this is a process flow for an electrically conductive substrate 1601. The process flow starts in FIG. 16 with blanket depositions on a substrate 1601 of a current collector (e.g. Ti/Au) layer 1602 and a cathode (e.g. LiCoO₂) layer 1603. The electrically conductive substrate may be conductive glass, silicon, mica, conductive ceramic, metal, rigid material, flexible material, plastic/polymer, etc.; furthermore, in embodiments for which laser patterning is done from the substrate side of the TFB the substrate will also need to meet the transparency requirements for laser processing. FIG. 17 shows the structure of FIG. 16 after the following processing: (1) laser die patterning from substrate or thin film side; and (2) cathode annealing, which for LiCoO₂, for example, may be an anneal at 600° C. or more for 2 hours or more in order to develop a crystalline structure. (Note: alternately, this structure can be formed by a single shadow mask.) Layers 1702 and 1703 are the processed layers 1602 and 1603, respectively. FIG. 18 shows the structure of FIG. 17 after blanket deposition of an electrolyte (e.g. LiPON) layer 1804 and anode (e.g. Li, Si) layer 1805, and ACC/initial protection (e.g. Ti/Cu) layer(s) 1806. Also, dry lithiation can be done, before the electrolyte deposition, if needed at this point in the process—for example, when fabricating non-Li anode cells, where the cell uses charge carriers from the original cathode without separately deposited Li anode. FIG. 19 shows the structure of FIG. 18 after die patterning (at some region, laser ablation is stopped at insulated electrolyte layer which can be done by using sub-UV lasers (e.g., 248 nm or 266 nm) or fs lasers to reduce short path possibility between conductive substrate and anode/ACC along laser cutting sidewall). Layers 1904, 1905 and 1906 are the processed layers 1804, 1805 and 1806, respectively, and 1920 is a buffer zone created in the insulating electrolyte layer 1904. FIG. 20 shows the structure of FIG. 19 after blanket encapsulation (e.g. polymer, dielectric layer) layer 2007 depositions—multiple layers may be deposited, as needed to provide the required device longevity, for example multiple layers of polymer/dielectric/metal. FIG. 21 shows the structure of FIG. 20 after laser ablations to expose the ACC contact areas—opened up to enable electrical contact to be made to the TFB from the top (contact to the bottom of the TFB stack being from the back of the electrically conductive substrate)—and die singulation. Layer 2107 is the processed layer 2007, and 2101 is the substrate for a single TFB. Furthermore, in some embodiments the deposition and patterning of an encapsulation layer, as shown in FIGS. 20 & 21, may be repeated one or more times using the same or different encapsulation materials. Comparing the device structure of FIG. 21 with that of FIGS. 9 & 15 it is apparent how the structure has been modified for the case of the conductive substrate—creating a buffer zone 1920 to reduce the chance of shorting between the substrate 2101 and the anode/ACC 1905/1906.

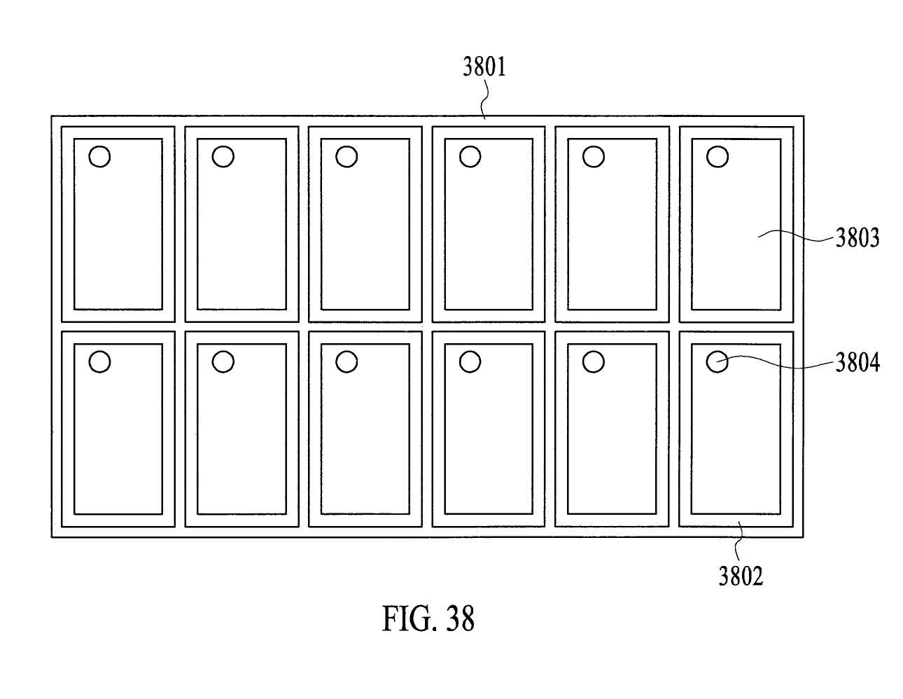

FIG. 38 is a plan view of a substrate 3801 with 12 TFBs prior to dicing, showing TFBs with anode areas in excess of 90% of the TFB footprint (device area). The figure shows the extent of the anode 3803 (underneath initial protection/ACC and encapsulation layers), exposed part 3804 of the ACC, and electrolyte buffer zone 3802 (underneath encapsulation layer), where the buffer area has been formed by stopping the laser ablation process in the middle of the LiPON layer. Note that electrical contact to the CCC is made through the substrate 3801, and that the position of the ACC contact area 3804 may be placed anywhere on the ACC. The configuration of FIG. 38 is an example of a device configuration for some embodiments of the devices resulting from the fabrication processes of FIGS. 16-21.

According to some embodiments, such as shown in FIGS. 21 and 38, a thin film battery may comprise: an electrically conductive substrate; a cathode current collector layer on the substrate; a cathode layer on the cathode current collector layer; an electrolyte layer completely covering the cathode layer and the cathode current collector layer; an anode layer on the electrolyte layer and an anode current collector layer on the anode layer, wherein an electrically insulating buffer area in the electrolyte layer, for electrically isolating the electrically conductive substrate from the edge of the anode layer, is not covered by the anode layer or the anode current collector layer, the electrically insulating buffer area completely surrounding the anode and the anode current collector. The thin film battery may further comprise an encapsulation layer, the encapsulation layer being on the top surface of the anode current collector layer and covering the complete top surface of the anode current collector layer, apart from an anode current collector contact area, the encapsulation layer further covering the electrically insulating buffer area.

According to embodiments, such as shown in FIGS. 16-21 and 38, a method of manufacturing thin film batteries may comprise: blanket depositing on an electrically conductive substrate a cathode current collector layer followed by a cathode layer; laser die patterning the cathode current collector layer and the cathode layer to form a first patterned stack comprising a cathode covering the top surface of a cathode current collector; blanket depositing an electrolyte layer, an anode layer and an anode current collector layer over the first patterned stack; laser die patterning the anode current collector layer, the anode layer, and the electrolyte layer and laser ablating portions of the anode current collector layer, the anode layer, and the electrolyte layer to form a third stack, the third stack comprising an anode current collector covering the top surface of an anode, and a revealed electrically insulating buffer area in the electrolyte layer to electrically isolate the electrically conductive substrate from the laser cut edge of the anode, the electrically insulating buffer area completely surrounding the anode and the anode current collector, and wherein a portion of the thickness of the electrolyte layer is ablated to form the electrically insulating buffer area. The method may further comprise annealing the cathode after the laser die patterning of the cathode current collector layer and the cathode layer. The method may further comprise blanket depositing an encapsulation layer on the third stack, and laser ablating the encapsulation layer to reveal a contact area of the anode current collector, to form a fourth device structure. The method may further comprise blanket depositing a second encapsulation layer on the fourth device stack and laser ablating portions of the second encapsulation layer to reveal a portion of the contact area of the anode current collector. Furthermore, the laser ablating of the electrolyte layer to form the electrically insulating buffer area in the electrolyte layer may utilize a femtosecond UV laser.

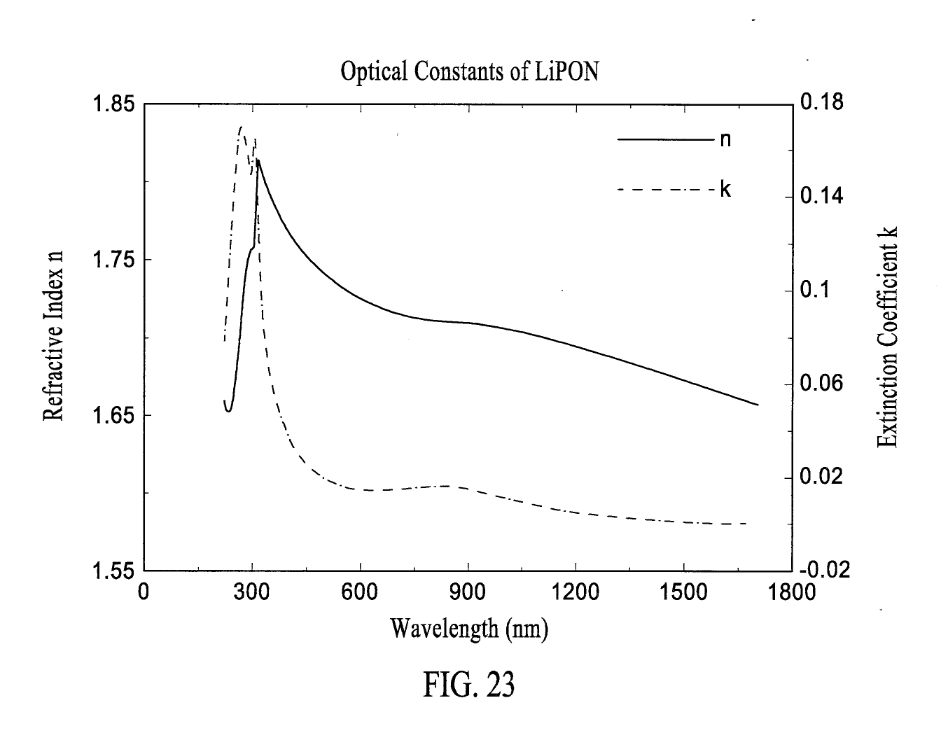

FIG. 23 shows the optical constants of typical LiPON material—1.5 microns of RF sputtered LiPON deposited on a glass substrate was characterized using spectroscopic ellipsometry. These optical properties indicate that a UV laser or femtosecond laser (including femtosecond UV lasers)—with laser wavelengths in the range of 200 nm to 400 nm, for example—will be effective in selectively ablating LiPON, that is, a laser ablation process that can readily be controlled to stop in the middle of the LiPON layer. (Note that for picosecond, nanosecond or microsecond lasers, the LiPON film will need to absorb some of the laser energy to ignite the ablation process, although absorption of femtosecond laser energy by the LiPON film is not necessary since a cold plasma dominates the ablation process at this wavelength.)

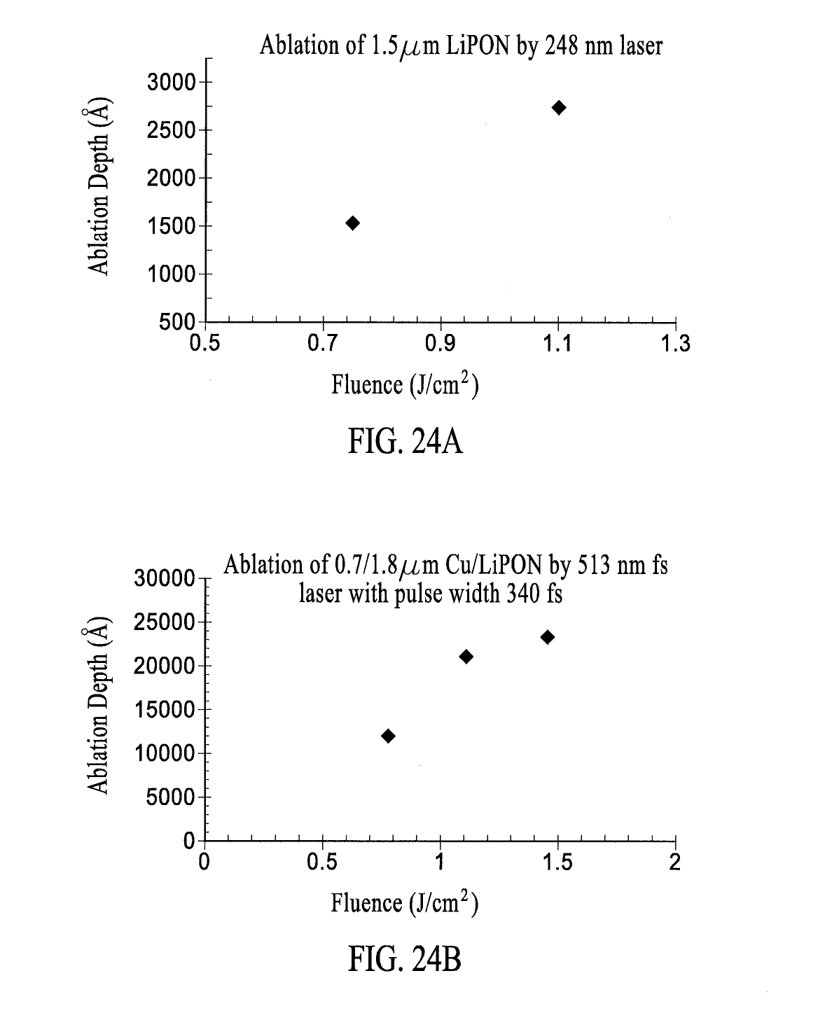

FIGS. 24A & B are provided as examples of the types of lasers and parameter ranges that may be used for selective ablation of an electrolyte material such as LiPON. FIG. 24A shows a plot of ablation depth as a function of laser fluence for ablation of a 1.5 micron thick layer of LiPON by a 248 nm laser; the laser pulse width is in the nanosecond to picosecond range for a sub-UV laser such as the 248 nm laser. This preliminary data shows that the 248 nm laser can selectively ablate LiPON—the ablation depth is seen to increase with laser power, indicating that sufficient laser energy has been deposited into the portion of the LiPON film to achieve a selective ablation relative to an underlying cathode layer, for example. Furthermore, it is expected that selective ablation can also be achieved using a 266 nm laser. FIG. 24B shows a plot of ablation depth as a function of laser fluence for ablation of 0.7/1.8 microns of Cu/LiPON by a 513 nm fs laser; the laser pulse width is below 1,000 femtoseconds for a femtosecond laser such as the 513 nm laser. This preliminary data shows that the 513 nm laser can selectively ablate LiPON

Conventional laser scribe or laser projection technology may be used for the laser patterning processes of present embodiments. The number of lasers may be: one, for example a UV/VIS laser with picosecond or femtosecond pulse width (selectivity controlled by laser fluence/dose); two, for example a combination of UV/VIS and IR lasers (selectivity controlled by laser wavelength/fluence/dose); or multiple (selectivity controlled by laser wavelength/fluence/dose). The scanning methods of a laser scribe system may be stage movement, beam movement by Galvanometers or both. The laser spot size of a laser scribe system may be adjusted from 10 microns (mainly for die pattering) to 1 cm in diameter. The laser area at the substrate for a laser projection system may be 0.1 mm² or larger. Furthermore, other laser types and configurations may be used. The laser patterning process describe herein is a laser ablation process—laser ablation is achieved by controlling: the laser scan speed and fluence for a spot laser; or the number of shots and fluence for an area laser. When laser patterning is implemented through a transparent substrate, the laser and substrate material will need to be compatible to avoid any significant absorption of laser energy within the substrate, and yet have good absorption of laser energy by layers that are to be ablated.

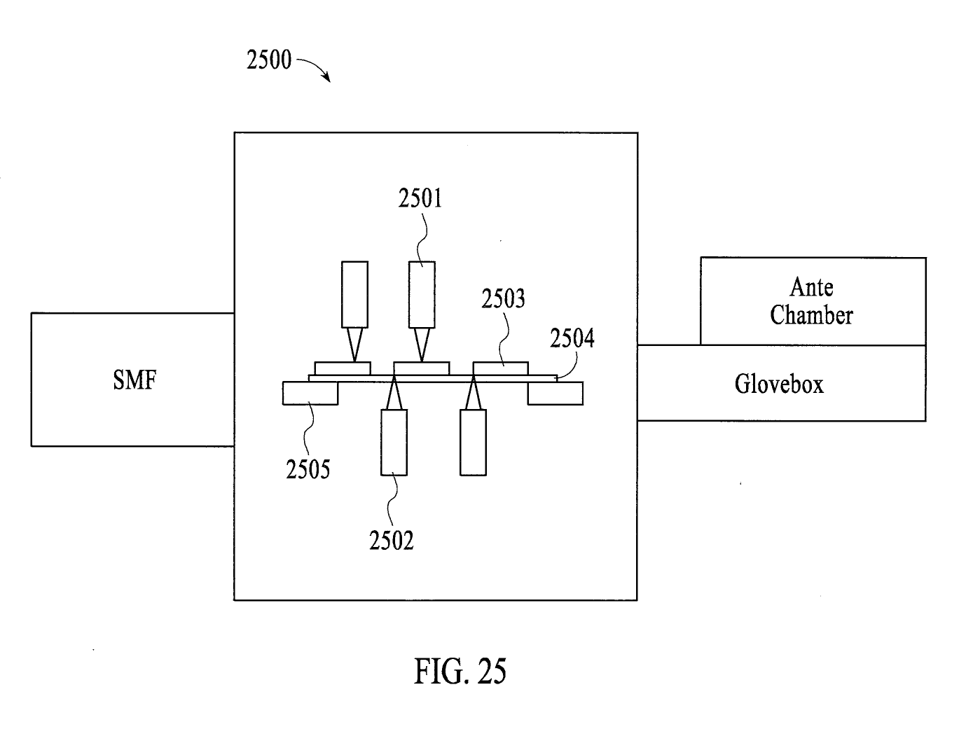

FIG. 25 is a schematic of a selective laser patterning tool 2500, according to embodiments. Tool 2500 includes lasers 2501 for patterning devices 2503 on a substrate 2504. Furthermore, lasers 2502 for patterning through the substrate 2504 are also shown, although lasers 2501 may be used for patterning through the substrate 2504 if the substrate is turned over, A substrate holder/stage 2505 is provided for holding and/or moving the substrate 2504. The stage 2505 may have apertures to accommodate laser patterning through the substrate, Tool 2500 may be configured for substrates to be stationary during laser ablation, or moving—the lasers 2501/2502 may also be fixed or movable; in some embodiments both the substrate and the lasers may be movable in which case the movement is coordinated by a control system. A stand-alone version of tool 2500 is shown in FIG. 25, including a front-end interface, such as a SMF, and also a glovebox and antechamber. The embodiment shown in FIG. 25 is one example of a tool according to some embodiments—many other configurations of the tool are envisaged, for example, the glove box may not be necessary in the case of lithium-free TFBs. Furthermore, the tool 2500 may be located in a room with a suitable ambient, like a dry-room as used in lithium foil manufacturing, and not require a glovebox.

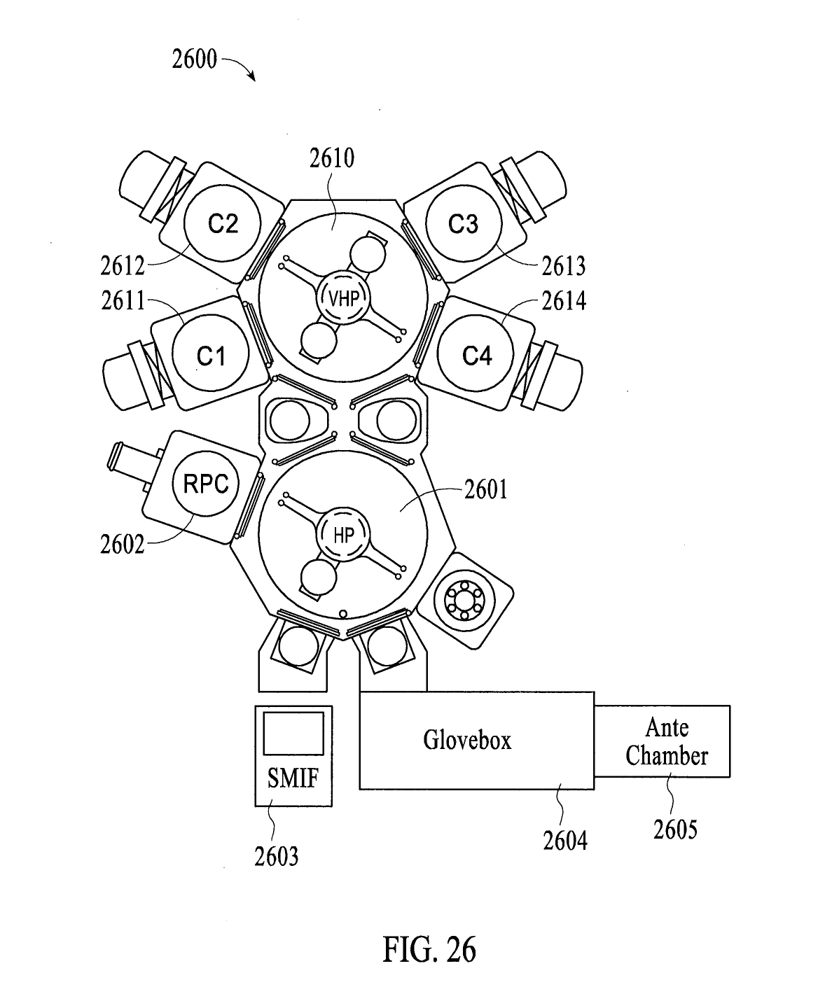

FIG. 26 is a schematic illustration of a processing system 2600 for fabricating a TFB, according to some embodiments. The processing system 2600 includes a standard mechanical interface (SMIF) 2603 to a cluster tool 2601/2610 equipped with a reactive plasma clean (RPC) chamber 2602 and process chambers C1-C4 (2611-2614), which may be utilized in the process steps described above. A glovebox 2604 may also be attached to the cluster tool. The glovebox can store substrates in an inert environment (for example, under a noble gas such as He, Ne or Ar), which is useful after alkali metal/alkaline earth metal deposition. An ante chamber 2605 to the glovebox may also be used if needed—the ante chamber is a gas exchange chamber (inert gas to air and vice versa) which allows substrates to be transferred in and out of the glovebox without contaminating the inert environment in the glovebox. (Note that a glovebox can be replaced with a dry room ambient of sufficiently low dew point as such is used by lithium foil manufacturers.) The chambers C1-C4 can be configured for process steps for manufacturing TFBs which may include, for example: deposition of a cathode layer (e.g. LiCoO₂ by RF sputtering); deposition of an electrolyte layer (e.g. Li₃PO₄ by RF sputtering in N₂); deposition of an alkali metal or alkaline earth metal; and selective laser patterning of blanket layers as described above. (Note that the laser patterning may be done in a cluster tool as described herein, or may be done in a stand alone tool.) It is to be understood that while a cluster arrangement has been shown for the processing system 500, a linear system may be utilized in which the processing chambers are arranged in a line without a transfer chamber so that the substrate continuously moves from one chamber to the next chamber.

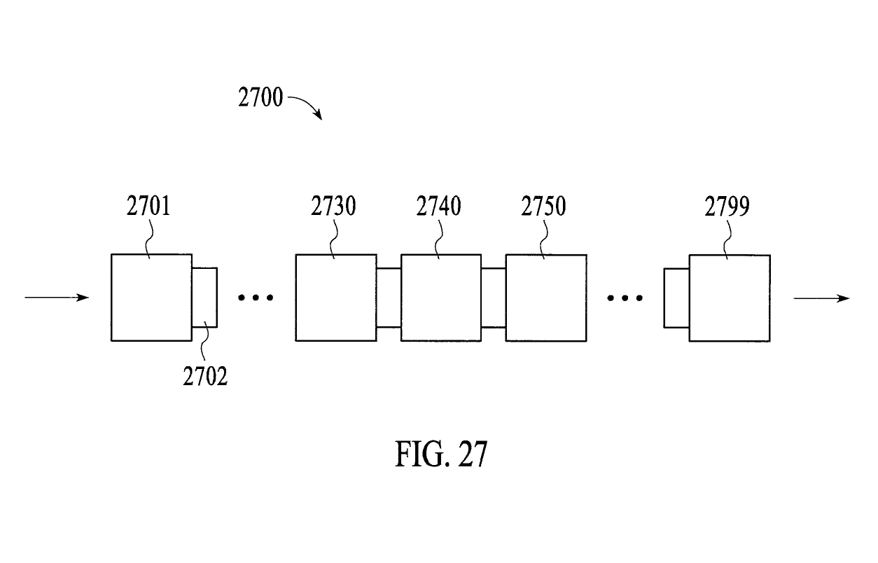

FIG. 27 shows a representation of an in-line fabrication system 2700 with multiple in-line tools 2701 through 2799, including tools 2730, 2740, 2750, according to some embodiments. In-line tools may include tools for depositing all the layers of a TFB, and a tool for three dimensionally restructuring the surface of one of the substrate and CCC. Furthermore, the in-line tools may include pre- and post-conditioning chambers. For example, tool 2701 may be a pump down chamber for establishing a vacuum prior to the substrate moving through a vacuum airlock 2702 into a deposition tool. Some or all of the in-line tools may be vacuum tools separated by vacuum airlocks. Note that the order of process tools and specific process tools in the process line will be determined by the particular TFB fabrication method being used, for example, as specified in the process flows described above. Furthermore, substrates may be moved through the in-line fabrication system oriented either horizontally or vertically. Yet furthermore, selective laser patterning modules may be configured for substrates to be stationary during laser ablation, or moving.

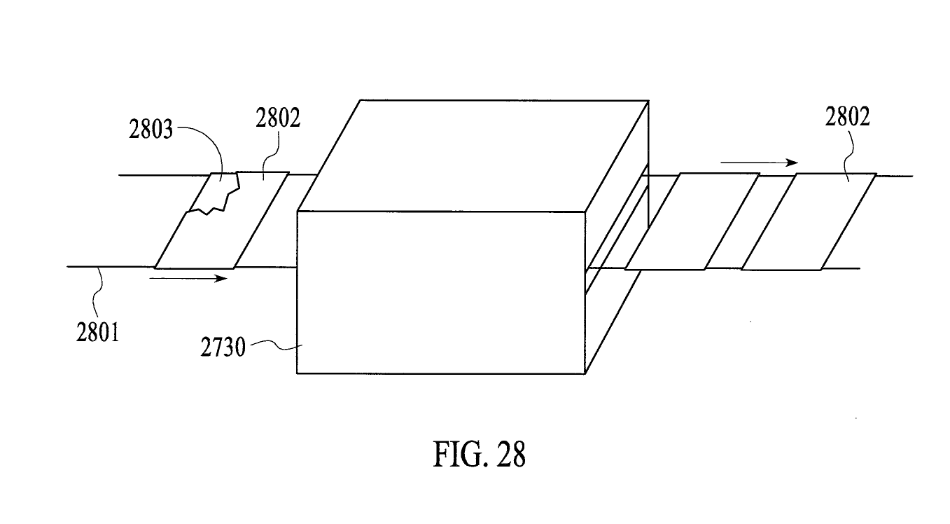

In order to illustrate the movement of a substrate through an in-line fabrication system such as shown in FIG. 27, in FIG. 28 a substrate conveyer 2801 is shown with only one in-line tool 2730 in place. A substrate holder 2802 containing a substrate 2803 (the substrate holder is shown partially cut-away so that the substrate can be seen) is mounted on the conveyer 2801, or equivalent device, for moving the holder and substrate through the in-line tool 2730, as indicated.

A first apparatus for forming thin film batteries according to embodiments of the present disclosure may comprise: a first system for blanket depositing on a substrate and laser die patterning a current collector layer and a cathode layer to form a first patterned stack; a second system for blanket depositing an electrolyte layer, an anode layer and an ACC over the first patterned stack, followed by (1) laser die patterning within the first die pattern, and (2) laser patterning to reveal a contact area of the CCC, by ablating a portion of the cathode, and to form an electrically insulating buffer area in the electrolyte layer to electrically isolate the laser cut edge of the patterned CCC/cathode from the laser cut edge of the patterned anode/ACC where the laser cut edges are in close proximity. The systems may be cluster tools, in-line tools, stand-alone tools, or a combination of one or more of the aforesaid tools. Furthermore, the systems may include some tools which are common to one or more of the other systems. Yet furthermore, the apparatus may comprise a third system for annealing the cathode layer after the laser die patterning and the laser patterning.

A second apparatus for forming thin film batteries according to embodiments of the present disclosure may comprise: a first system for blanket depositing on a substrate and laser die patterning a current collector layer and a cathode layer to form a first patterned stack, wherein a contact area of the CCC is revealed by ablation of a portion of the cathode; a second system for blanket depositing an electrolyte layer, an anode layer and an ACC over the first patterned stack, followed by (1) laser die patterning within the first die pattern, and (2) laser patterning to reveal the contact area of the CCC (without the need for any further cathode material ablation) and to form an electrically insulating buffer area in the electrolyte layer to electrically isolate the laser cut edge of the patterned CCC/cathode from the laser cut edge of the patterned anode/ACC where the laser cut edges are in close proximity. The systems may be cluster tools, in-line tools, stand-alone tools, or a combination of one or more of the aforesaid tools. Furthermore, the systems may include some tools which are common to one or more of the other systems. Yet furthermore, the apparatus may comprise a third system for annealing the cathode layer after the laser die patterning and the laser patterning.

A third apparatus for forming thin film batteries according to embodiments of the present disclosure may comprise: a first system for blanket depositing on a substrate and laser die patterning a current collector layer and a cathode layer to form a first patterned stack, wherein a contact area of a CCC is revealed by ablation of a portion of the cathode and all of an ACC is exposed; a second system for blanket depositing an electrolyte layer over the first patterned stack and laser ablating a portion of the electrolyte layer to expose a majority of the ACC, thus forming a second patterned stack; a third system for blanket depositing an anode layer and an initial protection layer over the second patterned stack and for laser die patterning the electrolyte, anode and initial protection layers within the first die pattern, laser ablating portions of the initial protection, anode, and electrolyte layers to reveal the contact area of the CCC, laser ablating the initial protection layer, anode layer and a portion of the thickness of the electrolyte to form an electrically insulating buffer area in the electrolyte layer to electrically isolate the laser cut edge of the patterned CCC/cathode from the laser cut edge of the patterned anode where the laser cut edges are in close proximity, and laser ablating a portion of the initial protection and electrolyte layers to reveal the contact area of the ACC. The systems may be cluster tools, in-line tools, stand-alone tools, or a combination of one or more of the aforesaid tools. Furthermore, the systems may include some tools which are common to one or more of the other systems. Yet furthermore, the apparatus may comprise a fourth system for annealing the cathode layer after the first laser die patterning and cathode patterning.

A fourth apparatus for forming thin film batteries on an electrically conductive substrate according to embodiments of the present disclosure may comprise: a first system for blanket depositing on a substrate and laser die patterning a current collector layer and a cathode layer to form a first patterned stack; a second system for blanket depositing an electrolyte layer, an anode layer and an ACC over the first patterned stack, followed by laser die patterning within the first die pattern. The systems may be cluster tools, in-line tools, stand-alone tools, or a combination of one or more of the aforesaid tools. Furthermore, the systems may include some tools which are common to one or more of the other systems. Yet furthermore, the apparatus may comprise a third system for annealing the cathode layer after the laser die patterning of the current collector layer and the cathode layer.

Although embodiments of the present disclosure have been described herein with reference to specific examples of TFB devices, process flows and manufacturing apparatus, the teaching and principles of the present disclosure may be applied to a wider range of TFB devices, process flows and manufacturing apparatus. For example, devices, process flows and manufacturing apparatus are envisaged for TFB stacks which are inverted from those described previously herein—the inverted stacks having ACC and anode on the substrate, followed by solid state electrolyte, cathode, CCC and encapsulation layer. Furthermore, those of ordinary skill in the art would appreciate how to apply the teaching and principles of the present disclosure to generate a wide range of devices, process flows and manufacturing apparatus.

Although embodiments of the present disclosure have been described herein with reference to TFBs, the teaching and principles of the present disclosure may also be applied to improved devices, process flows and manufacturing apparatus for fabricating other electrochemical devices, including electrochromic devices. Those of ordinary skill in the art would appreciate how to apply the teaching and principles of the present disclosure to generate devices, process flows and manufacturing apparatus which are specific to other electrochemical devices.

Although embodiments of the present disclosure have been described herein with reference to use of femtosecond lasers (including femtosecond UV lasers) for forming the buffer layers and ablation of LiPON, depending on the optical absorption characteristics of the materials femtosecond lasers may be used generally for laser ablation in the process flows described herein, including for die patterning.

Although embodiments of the present disclosure have been particularly described with reference to certain embodiments thereof, it should be readily apparent to those of ordinary skill in the art that changes and modifications in the form and details may be made without departing from the spirit and scope of the disclosure.

What is claimed is:

1. A thin film battery, comprising:
a substrate;
a cathode current collector and an anode current collector on said substrate, said cathode current collector and said anode current collector being electrically isolated from each other;
a cathode layer on said cathode current collector, wherein a contact area of said cathode current collector is not covered by said cathode layer;
an electrolyte layer completely covering the top surface of said cathode layer and covering a portion of said anode current collector, wherein the uncovered portion of said anode current collector is a contact area of said anode current collector;
an anode layer on said electrolyte layer and said anode current collector, wherein a portion of said anode contact area of said anode current collector is not covered by said anode layer, and wherein an electrically insulating buffer area in said electrolyte layer, for electrically isolating the edge of said cathode layer adjacent to said contact area of said cathode current collector from the edge of said anode layer, is not covered by said anode layer, said electrically insulating buffer area being between said contact area of said cathode current collector and said anode layer.

2. The thin film battery of claim 1, wherein said contact area of said cathode current collector is a corner portion of the top surface of said cathode current collector.

3. The thin film battery of claim 1, wherein said contact area of said anode current collector is a corner portion of the top surface of said anode current collector.

4. The thin film battery of claim 1, further comprising an initial protection layer, said initial protection layer being on the top surface of said anode layer and covering the complete top surface of said anode layer without extending beyond the edges of the anode layer.

5. The thin film battery of claim 4, further comprising an encapsulation layer completely covering said initial protection layer, said anode layer, said electrolyte layer, and said cathode layer.

6. A method of manufacturing thin film batteries, comprising:
blanket depositing on a substrate a current collector layer and a cathode layer;
laser die patterning said current collector layer and said cathode layer to form a cathode current collector and an anode current collector and laser ablating portions of said cathode layer to reveal a contact area of said cathode current collector and to expose all of said anode current collector, to form a first patterned stack;
blanket depositing an electrolyte layer over said first patterned stack;
laser ablating a portion of said electrolyte layer to expose a contact area of said anode current collector, to form a second patterned stack;
blanket depositing an anode layer and an initial protection layer over said second patterned stack;
laser die patterning said electrolyte, said anode and said initial protection layers within the die pattern of the laser die patterning of said current collector layer and said cathode layer;
laser ablating portions of said initial protection, said anode, and said electrolyte layers to reveal said contact area of said cathode current collector, and laser ablating said initial protection layer, said anode layer and a portion of the thickness of said electrolyte layer to form an electrically insulating buffer area in said electrolyte layer to electrically isolate the laser cut edge of the cathode layer adjacent to said contact area of the cathode current collector from the laser cut edge of the patterned anode, and laser ablating a portion of said initial protection layer and said electrolyte layer to reveal said contact area of said anode current collector, to form a third device stack.

7. The method of claim 6, wherein said cathode layer is annealed after said laser die patterning of said current collector layer and said cathode layer and said laser ablating of said portions of said cathode layer.

8. The method of claim 6, further comprising:
blanket depositing an encapsulation layer on said third device stack; and
laser ablating said encapsulation layer to reveal a portion of said contact area of said cathode current collector and a portion of said contact area of said anode current collector, to form a fourth device structure.

9. The method of claim 8, further comprising:
blanket depositing a second encapsulation layer on said fourth device stack; and
laser ablating said second encapsulation layer to reveal a second portion of said contact area of said cathode current collector and a second portion of said contact area of said anode current collector, wherein said second portion is smaller than said first portion.

10. The method of claim 6, wherein said laser ablating said electrolyte layer to form said electrically insulating buffer area in said electrolyte layer utilizes a femtosecond UV laser.

11. An apparatus for manufacturing thin film batteries on a substrate comprising:
a first system for blanket depositing on a substrate a current collector layer and a cathode layer and laser die patterning said current collector layer and said cathode layer to form a cathode current collector and an anode current collector and laser ablating portions of said cathode layer to reveal a contact area of said cathode current collector and to expose all of said anode current collector, to form a first patterned stack;
a second system for blanket depositing an electrolyte layer over said first patterned stack and laser ablating a portion of said electrolyte layer to expose a contact area of said anode current collector, to form a second patterned stack; and
a third system for blanket depositing an anode layer and an initial protection layer over said second patterned stack, laser die patterning said electrolyte, said anode and said initial protection layers within the die pattern of the laser die patterning of said current collector layer and said cathode layer, laser ablating portions of said initial protection, said anode, and said electrolyte layers to reveal said contact area of said cathode current collector, laser ablating said initial protection layer, said anode layer and a portion of the thickness of said electrolyte layer to form an electrically insulating buffer area in said electrolyte layer to electrically isolate the laser cut edge of the cathode layer adjacent to said contact area of the cathode current collector from the laser cut edge of the patterned anode, and laser ablating a portion of said initial protection layer and said electrolyte layer to reveal said contact area of said anode current collector, to form a third device stack.

12. The apparatus of claim 11, wherein said first, second and third systems are in-line tools.

13. The apparatus of claim 11, further comprising a fourth system for annealing said cathode layer after said laser die patterning of said current collector layer and said cathode layer and said laser ablating of said portions of said cathode layer.

14. The apparatus of claim 11, wherein said third system includes a femtosecond UV laser for laser ablating said electrolyte layer to form said electrically insulating buffer area in said electrolyte layer.

15. The apparatus of claim 11, further comprising a fifth system for blanket depositing an encapsulation layer on said third device stack and laser ablating said encapsulation layer to reveal a portion of said contact area of said cathode current collector and a portion of said contact area of said anode current collector.
